(19) United States
(12) Patent Application Publication
(10) Pub. No.: US 2020/0339842 A1
(43) Pub. Date: Oct. 29, 2020

(54) PRESSURE-SENSITIVE ADHESIVE SHEET

(71) Applicant: NITTO DENKO CORPORATION, Osaka (JP)

(72) Inventors: Shigeki WATANABE, Osaka (JP); Masahito NIWA, Osaka (JP)

(73) Assignee: NITTO DENKO CORPORATION, Osaka (JP)

(21) Appl. No.: 16/855,178

(22) Filed: Apr. 22, 2020

(30) Foreign Application Priority Data
Apr. 26, 2019 (JP) 2019-086382

(51) Int. Cl. C09J 7/38; C09J 107/00; C09J 199/00; C09J 193/04; C09J 115/00

(52) U.S. Cl. CPC C09J 7/383; C09J 107/00; C09J 2203/326; C09J 193/04; C09J 115/00; C09J 199/00

(57) ABSTRACT

Provided is a PSA sheet that shows excellent adhesive strength to both high-polar and low-polar adherends with reduced dependence on fossil-resource-based materials. The PSA sheet has a PSA layer formed from a natural rubber-based PSA. At least 20% by weight of all repeat units forming the base polymer of the PSA are derived from an acrylic monomer. Biomass-derived carbons account for at least 50% of the total carbon content of the PSA layer. The PSA sheet has an adhesive strength of 18 N/20 mm or greater to a stainless steel plate (after left at 50° C. for 2 h) and an adhesive strength of 15 N/20 mm or greater to a polypropylene plate (after left at 50° C. for 2 h).

### CROSS-REFERENCE

The present application claims priority to Japanese Patent Application No. 2019-08638 filed on Apr. 26, 2019, whose entire content is incorporated herein by reference.

### BACKGROUND OF THE INVENTION

### 1. Field of the Invention

The present invention relates to a pressure-sensitive adhesive sheet.

### 2. Description of the Related Art

In general, pressure-sensitive adhesive (PSA) exists as a soft solid (a viscoelastic material) in a room temperature range and has a property to adhere easily to an adherend with some pressure applied. With such properties, PSA is widely used as a joining means having high operability and high reliability of adhesion in various industrial fields such as home appliances, automobiles, various types of machinery, electrical equipment and electronic equipment. A PSA sheet is also preferably used, for example, for fixing components of electronic devices such as mobile phones, smart phones, and tablet-type personal computers. Documents disclosing this type of conventional art include Japanese Patent No. 6104500 and Japanese Patent Application Publication No. 2015-221847.

### SUMMARY OF THE INVENTION

Conventionally, as for PSA sheets for electronic device applications, for instance, acrylic PSA comprising an acrylic polymer as the base polymer has been mainly used (e.g. Japanese Patent No. 6104500). With respect to non-acrylic PSA, for instance, as in Japanese Patent Application Publication No. 2015-221847, it has been suggested to use a rubber-based PSA in which a rubber-based block copolymer such as styrene-butadiene block copolymer is used as the base polymer.

Here, both the acrylic polymer and the rubber-based block copolymer are typically obtained by mainly using fossil resources such as petroleum. On the other hand, in late years, much attention has been placed on environmental problems such as global warming with expectations for reducing the usage of materials based on fossil resources such as petroleum. With respect to PSA sheets, it is also desired to reduce the usage of fossil-resource-based materials. However, it is not easy to obtain a high-performance PSA sheet while reducing the dependence on fossil-resource-based materials. For instance, in a PSA sheet required to provide high performance such as those used in electronic devices, it is significant that the adhesive properties are maintained or improved while the dependence on fossil-resource-based materials are decreased.

The present invention has been made in view of these circumstances with an objective to provide a PSA sheet that reduces the dependence on fossil-resource-based materials and shows excellent adhesive strength to both a high-polar adherend and a low-polar adherend.

The present description provides a PSA sheet having a PSA layer formed from a natural rubber-based PSA. The PSA comprises a base polymer in which at least 20% by weight of all repeat units forming the base polymer is derived from an acrylic monomer. Of the total carbon content of the PSA layer, biomass-derived carbons account for at least 50%. The PSA sheet has a to-stainless-steel-plate adhesive strength of 18 N/20 mm or greater when determined at a peel angle of 180° at a tensile speed of 300 mm/min in an environment at 23° C. and 50% RH after the PSA sheet is press-bonded to a stainless steel plate as an adherend and the resultant is left at 50° C. for two hours; and has a to-propylene-plate adhesive strength of 15 N/20 mm or greater when determined at a peel angle of 180° at a tensile speed of 300 mm/min in an environment at 23° C. and 50% RH after the PSA sheet is press-bonded to a polypropylene plate as an adherend and the resultant is left at 50° C. for two hours. According to the PSA sheet in this embodiment, the dependence on fossil-resource-based materials can be reduced with the use of the natural rubber-based PSA comprising at least the prescribed percent acrylic monomer-derived repeat unit while high adhesive strength can be obtained to both a high-polar adherend such as a stainless steel plate and a low-polar adherend such as a polypropylene plate. For instance, it is possible to achieve strong and reliable fastening between an adherend formed of a high-polar material such as a stainless steel plate and another adherend formed of a low-polar material such as polyolefin, etc. In a typical embodiment, the PSA sheet has a to-stainless-steel-plate adhesive strength greater than 18.0 N/20 mm when determined at a peel angle of 180° at a tensile speed of 300 mm/min in an environment at 23° C. and 50% RH after the PSA sheet is press-bonded to a stainless steel plate as an adherend and the resultant is left at 50° C. for two hours.

In some preferable embodiments, the PSA layer comprises a plant-derived tackifier. By using the plant-derived tackifier, the properties of the PSA sheet can be improved without depending on fossil-resource-based materials.

In some preferable embodiments, the PSA layer comprises at least one species as a tackifier T1 selected among rosin-based tackifier resins and terpene-based tackifier resins, and further comprises a phenolic tackifier resin as a tackifier T2. The combined use of tackifiers T1 and T2 as the tackifier can preferably bring about high adhesive strength to high-polar and low-polar adherends.

In some preferable embodiments, the tackifiers T1 and T2 have weight fractions A1 and A2, respectively, at an A2 to A1 ratio (A2/A1) of 0.05 or higher and below 0.40. By setting the blend ratio of tackifiers T1 and T2 to satisfy the A2/A1 ratio, the effect of the art disclosed herein (i.e. excellent adhesive strength to both high-polar and low-polar adherends) can be preferably obtained.

In some preferable embodiments, the weight fraction A1 of the tackifier T1 is greater than 50 parts by weight and less than 100 parts by weight to 100 parts by weight of the base polymer. When the tackifier T1 is used within this range, the effect of the art disclosed herein can be preferably obtained.

In some preferable embodiments, the weight fraction A2 of the tackifier T2 is 5 parts by weight or greater and less than 30 parts by weight to 100 parts by weight of the base polymer. When the tackifier T2 is used within this range, the effect of the art disclosed herein can be preferably obtained.

In some preferable embodiments, the total tackifier content of the PSA layer is less than 100 parts by weight to 100 parts by weight of the base polymer. When the tackifiers are used in an amount less than the prescribed level, the PSA layer can readily have an even surface, preferably satisfying desirable adhesive properties.

The PSA sheet disclosed herein is preferably formed as an adhesively double-faced PSA sheet, that is, a double-faced PSA (two-sided, double-sided) sheet. For instance, the double-faced PSA sheet is suited for fastening parts. When one member to be fastened is formed of a high-polar material such as a stainless steel plate and another member to be fastened is formed of a low-polar material such as polyolefin, the double-faced PSA sheet can strongly fasten the two members subject to joining; and it can be a highly reliable bonding means.

The PSA sheet disclosed herein shows excellent adhesive strength to both a high-polar adherend and a low-polar adherend; and therefore, it is suited for use in electronic devices required to provide high performance and it may show an excellent ability to maintain bonding to parts formed of both high-polar and low-polar materials in an electronic device. Accordingly, it is especially suited for fixing parts of electronic devices.

### BRIEF DESCRIPTION OF THE DRAWINGS

FIG. 1 shows a cross-sectional diagram schematically illustrating the constitution of the PSA sheet according to an embodiment.

FIG. 2 shows a cross-sectional diagram schematically illustrating the constitution of the PSA sheet according to another embodiment.

FIG. 3 shows a cross-sectional diagram schematically illustrating the constitution of the PSA sheet according to another embodiment.

### DETAILED DESCRIPTION OF THE INVENTION

Preferred embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field.

In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

The concept of PSA sheet here encompasses so-called PSA tapes, PSA labels, PSA films and the like. The PSA layer is typically formed in a continuous form, but is not limited to such a form. For instance, the PSA layer may be formed in a regular or random pattern of dots, stripes, etc. The PSA sheet disclosed herein may be in a rolled form or in a flat sheet form or can be further cut, punched, etc. into suitable shapes in accordance with the purpose and usage.

As used herein, the term “PSA” refers to, as described earlier, a material that exists as a soft solid (a viscoelastic material) in a room temperature range and has a property to adhere easily to an adherend with some pressure applied. As defined in “Adhesion: Fundamental and Practice” by C. A. Dahlquist (McLaren & Sons (1966), P. 143), the PSA referred to here can be a material that has a property satisfying complex tensile modulus E*(1 Hz)<10⁷ dyne/cm² (typically, a material that exhibits the described characteristics at 25° C.).

### Constitution of PSA Sheet

The PSA sheet disclosed herein includes a PSA layer. The PSA sheet may be, for instance, a PSA sheet without substrate, or a PSA sheet which does not have any substrate, support layer, or backing layer. A PSA sheet without substrate has a first adhesive face formed of one surface of the PSA layer and a second adhesive face formed of the other surface of the PSA layer. Alternatively, the PSA sheet disclosed herein may be a substrate-supported PSA sheet in which the PSA layer is layered on one or each face of a support substrate. Hereinafter, the support substrate may be simply referred to as a “substrate.”

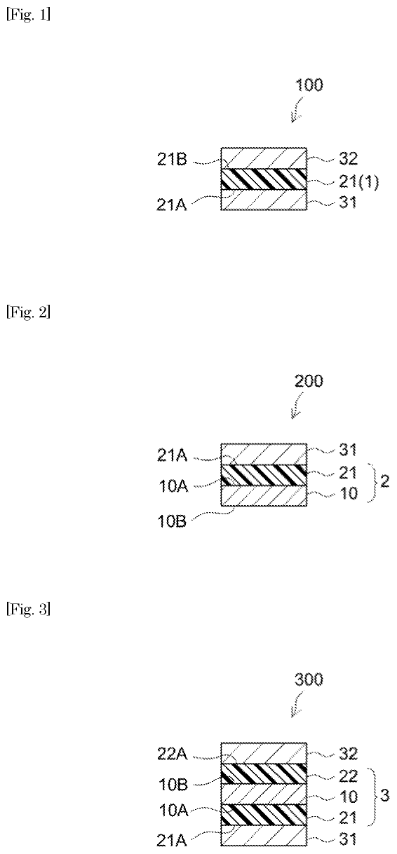

FIG. 1 schematically illustrates the structure of the PSA sheet according to an embodiment. PSA sheet 1 is configured as a PSA sheet without substrate, formed of a PSA layer 21. PSA sheet 1 is used by applying the first adhesive face 21A formed of one surface (first face) of PSA layer 21 and the second adhesive face 21B formed of the other surface (second face) of PSA layer 21 to different locations of adherend(s). The locations to which the adhesive faces 21A and 21B are applied can be the corresponding locations of different members or different locations of a single member. As shown in FIG. 1, PSA sheet 1 prior to use (i.e. before applied to an adherend) may be a constituent of a release-linered PSA sheet 100 in which the first and second adhesive faces 21A and 21B are protected by release liners 31 and 32 each having a release face at least on the side facing the PSA layer 21. Such a PSA sheet with release liner can be referred to as a PSA transfer tape, or a PSA sheet with release liner without substrate. The release liners 31 and 32 which may be preferably used are, for example, those respectively having a release layer provided by treatment with a release agent on one side of a sheet-shaped substrate (liner substrate) so that the side serves as a release surface. Alternatively, omitting release liner 32, a release liner 31 having release faces on both sides may be used; this and the PSA sheet 1 may be layered and wound together to form a roll of a release-linered PSA sheet in which the second adhesive face 21B is abutted and protected by the backside of release liner 31.

FIG. 2 schematically illustrates the structure of a PSA sheet according to an embodiment. The PSA sheet 2 is configured as a single-faced PSA sheet with a substrate, including a support substrate sheet (such as a resin film) 10 having a first surface 10A and a second surface 10B, and a PSA layer 21 provided on the side of the first surface 10A. The PSA layer 21 is provided securely on the side of the first surface 10A of the support substrate 10, namely provided without intending to separate the PSA layer 21 from the support substrate 10. As shown in FIG. 2, PSA sheet 2 prior to use may be a constituent of a release-linered PSA sheet 200 in which the surface (adhesive face) 21A of the PSA layer 21 is protected by release liner 31 having a release surface at least on the side facing the PSA layer 21. Alternatively, omitting release liner 31, a support substrate 10 having a second surface 10B that serves as a release surface may be used and PSA sheet 2 may be wound to form a roll in which the adhesive face 21A is abutted and protected by the second face (backside) 10B of support substrate 10.

FIG. 3 schematically illustrates the structure of the PSA sheet according to yet another embodiment. PSA sheet 3 is configured as a substrate-supported double-faced PSA sheet comprising a support substrate sheet (e.g. resin film) 10 having first and second faces 10A and 10B, a first PSA layer 21 fixed to the first face 10A side and a second PSA layer 22 fixed to the second face 10B side. As shown in FIG. 3, PSA sheet 3 prior to use may be a constituent of a release-linered PSA sheet 300 in which the surfaces (first and second adhesive faces) 21A and 22A of PSA layer 21 are protected by release liners 31 and 32. Alternatively, omitting release liner 32, a release liner 31 having release faces on both sides may be used; this and the PSA sheet 3 may be layered and wound together to form a roll of a release-linered PSA sheet in which the second adhesive face 22A is abutted and protected by the backside of release liner 31.

As the release liner, it is possible to use a release liner having a release layer on the surface of a liner substrate such as resin film and paper or a release liner formed from a low-adhesive material such as a polyolefinic resin (e.g. polyethylene, polypropylene) and a fluororesin. The release layer can be formed by subjecting the liner substrate to surface treatment with a release agent such as a silicone-based, long-chain alkyl-based, fluorine-based agent, and molybdenum sulfide. For use in electronic devices, from the standpoint of avoiding the occurrence of paper dust, a release liner having a release layer on the surface of resin film or a release liner formed from a low-adhesive material is preferable.

### Adhesive Properties of PSA Sheet

### (To-SUS Adhesive Strength)

In some embodiments, the PSA sheet disclosed herein is characterized by having a to-stainless-steel-plate (to-SUS) adhesive strength of 18 N/20 mm or greater when determined at a peel angle of 180° at a tensile speed of 300 mm/min in an environment at 23° C. and 50% RH after the PSA sheet is press-bonded to a stainless steel plate as an adherend and the resultant is left at 50° C. for two hours. The PSA sheet satisfying this property shows excellent adhesive strength to a high-polar adherend such as a stainless steel plate and is able to strongly bond to the high-polar adherend. In a typical embodiment, the PSA sheet has a to-SUS adhesive strength greater than 18.0 N/20 mm. From the standpoint of achieving bonding with higher reliability, the to-SUS adhesive strength is preferably about 19 N/20 mm or greater (specifically 19.0 N/20 mm or greater), more preferably about 20 N/20 mm or greater (specifically 20.0 N/20 mm or greater), yet more preferably about 21 N/20 mm or greater (specifically 21.0 N/20 mm or greater), or particularly preferably about 22 N/20 mm or greater (specifically 22.0 N/20 mm or greater). On the other hand, from the standpoint of readily increasing the biomass carbon ratio of the PSA layer, the to-SUS adhesive strength can be, for instance, about 50 N/20 mm or less, about 40 N/20 mm or less, or even about 30 N/20 mm or less. The to-SUS adhesive strength is determined by the method described later in Examples. The PSA sheet disclosed herein encompasses an embodiment where the to-SUS adhesive strength is not limited; and in such an embodiment, the PSA sheet is not limited to those having this property.

### (To-PP Adhesive Strength)

In some embodiments, the PSA sheet disclosed herein has a to-polypropylene-plate (to-PP) adhesive strength of 15 N/20 mm or greater (specifically, 15.0 N/20 mm or greater) when determined at a peel angle of 180° at a tensile speed of 300 mm/min in an environment at 23° C. and 50% RH after the PSA sheet is press-bonded to a polypropylene plate as an adherend and the resultant is left at 50° C. for two hours. The PSA sheet satisfying this property shows excellent adhesive strength to a low-polar adherend such as a PP plate and is able to strongly bond to the low-polar adherend. From the standpoint of achieving bonding with higher reliability, the to-PP adhesive strength is preferably about 16 N/20 mm or greater (specifically 16.0 N/20 mm or greater), more preferably about 17 N/20 mm or greater (specifically 17.0 N/20 mm or greater), yet more preferably about 18 N/20 mm or greater (specifically 18.0 N/20 mm or greater), or particularly preferably about 19 N/20 mm or greater (specifically 19.0 N/20 mm or greater). On the other hand, from the standpoint of readily increasing the biomass carbon ratio of the PSA layer, the to-PP adhesive strength can be, for instance, about 40 N/20 mm or less, about 30 N/20 mm or less, or even about 25 N/20 mm or less. The to-PP adhesive strength is determined by the method described later in Examples. The PSA sheet disclosed herein encompasses an embodiment where the to-PP adhesive strength is not limited; and in such an embodiment, the PSA sheet is not limited to those having this property.

### PSA Layer

### (Biomass Carbon Ratio)

In the PSA sheet disclosed herein, the PSA layer has a biomass carbon ratio (or biobased content) of 50% or higher. A high biomass carbon ratio of the PSA layer means low usage of fossil-resource-based materials typified by petroleum and the like. From such a standpoint, it can be said that the higher the biomass carbon ratio of the PSA layer is, the more preferable it is. For instance, the biomass carbon ratio of the PSA layer can be 60% or higher, 70% or higher, 75% or higher, or even 80% or higher. The maximum biomass carbon ratio is 100% by definition and the biomass carbon ratio is typically below 100%. From the standpoint of readily obtaining adhesive strength to adherends, in some embodiments, the biomass carbon ratio of the PSA layer can be, for instance, 95% or lower. When adhesive properties are of greater importance, it can be 90% or lower, or even 85% or lower. It is noted that the biobased content of general acrylic PSA is about zero to 30%; or at most, it is less than 40%.

As used herein, the biomass-derived carbon (or sometimes abbreviated to the “biomass carbon”) refers to carbon (renewable carbon) derived from a biomass material, that is, a material derived from a renewable organic resource. The biomass material refers to a material derived from a bioresource (typically a photosynthetic plant) that is continuously renewable typically in the sole presence of sun light, water and carbon dioxide. Accordingly, the concept of biomass material excludes materials based on fossil resources (fossil-resource-based materials) that are exhausted by using after mining.

The “biomass carbon ratio” (or the “biobased content”) here refers to the ratio of biomass carbons to all carbons in a measurement sample (specimen) and is determined based on ASTM D6866. Among the methods described in ASTM D6866, Method B is preferred for it is highly precise. The same applies to the biobased degrees of the PSA layer, substrate and PSA sheet. The biomass carbon ratio in this description is determined from the ¹⁴C concentration ratio (unit: pMC (percent Modern Carbon)) relative to the standard value (modern reference standard) defined by a standard substance.

### (Base Polymer)

The PSA sheet disclosed herein has a PSA layer formed from a natural rubber-based PSA. The natural rubber-based PSA refers to a PSA whose base polymer include more than 50% natural-rubber-based polymer(s) which can be one, two or more species of polymers selected among natural rubbers and modified natural rubbers. Herein, the concept of natural-rubber-based polymer encompasses both natural rubbers and modified natural rubbers. The base polymer of the PSA refers to a rubbery polymer in the PSA. The rubbery polymer refers to a polymer that shows rubber elasticity in a temperature range around room temperature. In addition to the natural-rubber-based polymer(s), the base polymer of the PSA may include a non-natural-rubber-based polymer as a secondary component. Examples of the non-natural-rubber-based polymer include acrylic polymers, synthetic rubber-based polymers, polyester-based polymers, urethane-based polymers, polyether-based polymers, silicone-based polymers, polyamide-based polymers and fluoropolymers known in the field of PSA.

In the PSA in the art disclosed herein, at least 20% (by weight) of all the repeat units forming the base polymer is attributed to an acrylic monomer-derived repeat unit. In other words, at least 20% of the total weight of the base polymer comes from the acrylic monomer. Hereinafter, the ratio of the weight coming from the acrylic monomer to the total weight of the base polymer may be referred to as the “acrylate ratio.” When the base polymer comprises at least the certain percentage of the acrylic monomer derived repeat unit, the cohesive strength of the natural rubber-based PSA can be increased; and, for instance, the adhesive strength can be increased without requiring the use of a vulcanizer or sulfur-containing vulcanization accelerator.

From the standpoint of increasing the cohesive strength of the PSA, the acrylate ratio of the base polymer can be, for instance, higher than 20% by weight, preferably 24% by weight or higher, 28% by weight or higher, or even 33% by weight or higher. From the standpoint of placing more emphasis on the cohesive strength, in some embodiments, the acrylate ratio of the base polymer can be 35% by weight or higher, 38% by weight or higher, or even 40% by weight or higher. The maximum acrylate ratio of the base polymer is selected so that the PSA layer has a biomass carbon ratio of 50% by weight or higher. From the standpoint of increasing the biomass carbon ratio of the PSA layer, the lower the acrylate ratio of the base polymer is, the more advantageous it is. From such a standpoint, the acrylate ratio of the base polymer is suitably below 70% by weight, preferably below 60% by weight, possibly below 55% by weight, or even below 50% by weight. From the standpoint of further increasing the biomass carbon ratio, in some embodiments, the acrylate ratio of the base polymer can be below 45% by weight, below 42% by weight, or even below 39% by weight.

The acrylic monomer-derived repeat unit in the base polymer may be a repeat unit forming an acrylate-modified natural rubber. The PSA sheet disclosed herein can be preferably made in an embodiment where the base polymer of the PSA comprises an acrylate-modified natural rubber. Here, the acrylate-modified natural rubber refers to a natural rubber grafted with an acrylic monomer. The PSA in such an embodiment may further comprise a base polymer (e.g. natural rubber) that is free of an acrylic monomer-derived repeat unit. The base polymer of the PSA may further include an acrylic monomer-derived repeat unit as a repeat unit forming a polymer which is not an acrylate-modified natural rubber.

As used herein, the acrylic monomer refers to a monomer having at least one (meth)acryloyl group per molecule. The “(meth)acryloyl” here comprehensively refers to acryloyl and methacryloyl. Thus, the concept of acrylic monomer here encompasses both a monomer having an acryloyl group (acrylic monomer) and a monomer having a methacryloyl group (methacrylic monomer).

In the acrylate-modified natural rubber, the acrylic monomer grafted on the natural rubber is not particularly limited. Examples include: an alkyl (meth)acrylate having an alkyl group with 1 to 8 carbons at the ester terminus, such as methyl (meth)acrylate, ethyl (meth)acrylate and butyl (meth)acrylate; and (meth)acrylic acid. These can be used singly as one species or in a combination of two or more species. Acrylic monomers preferred from the standpoint of increasing the cohesive strength include (meth)acrylic acid and an alkyl (meth)acrylate having an alkyl group with 1 to 2 carbons at the ester terminus. From the standpoint of reducing the corrosiveness, a carboxy group-free acrylic monomer is advantageous. From such a standpoint, an alkyl (meth)acrylate is preferable. In particular, methyl methacrylate (MMA) and ethyl methacrylate are preferable; and MMA is especially preferable.

Of the total weight of the acrylate-modified natural rubber, the ratio of the weight of the acrylic monomer derived repeat unit (or the acrylate modification rate) should be in the range above 0% by weight and below 100% by weight; and it is not particularly limited. From the standpoint of enhancing the effect to increase the cohesive strength, the acrylate modification rate of the acrylate-modified natural rubber is suitably 1% by weight or higher, possibly 5% by weight or higher, 10% by weight or higher, or even 15% by weight or higher. From the standpoint of obtaining greater cohesive strength, in some embodiments, the acrylate modification rate can be, for instance, above 20% by weight, 24% by weight or higher, 28% by weight or higher, 33% by weight or higher, 35% by weight or higher, 38% by weight or higher, or even 40% by weight or higher. From the standpoint of increasing the biomass carbon ratio, the acrylate modification rate of the acrylate-modified natural rubber is suitably below 80% by weight, preferably below 70% by weight, possibly below 60% by weight, below 55% by weight, below 50% by weight, or even below 45% by weight.

The acrylate-modified natural rubber can be produced by a known method or a commercially-available product can be used. Examples of the production method of acrylate-modified natural rubber include a method where addition polymerization is carried out upon addition of the acrylic monomer to the natural rubber, a method where a pre-formed oligomer of the acrylic monomer is mixed with and added onto the natural rubber, and an intermediate method between these. The ratio between the natural rubber and the acrylic monomer as well as other production conditions can be suitably selected so as to obtain an acrylate-modified natural rubber having a desired acrylate modification rate. The natural rubber used in production of the acrylate-modified natural rubber is not particularly limited. For instance, a suitable species can be selected among various natural rubbers that are generally available, such as a ribbed smoked sheet (RSS), pale crepe, standard Malaysian rubber (SMR) and standard Vietnamese rubber (SVR). When a natural rubber is used in combination with the acrylate-modified natural rubber, the natural rubber can also be selected among the same various natural rubbers. The natural rubber is typically used upon mastication by a usual method.

The Mooney viscosity of the natural rubber used in producing the acrylate- modified natural rubber is not particularly limited. For instance, it is possible to use a natural rubber having a Mooney viscosity MS₁₊₄(100 ° C.) (i.e. a Mooney viscosity determined at MS (1+4) 100° C.) in a range of about 10 or greater and 120 or less. The natural rubber's Mooney viscosity MS₁₊₄(100° C.) can be, for instance, 100 or less, 80 or less, 70 or less, or even 60 or less. With decreasing Mooney viscosity MS₁₊₄(100° C.), it tends to readily show initial tack. This is advantageous in increasing the efficiency of application to adherend. From such a standpoint, in some embodiments, the Mooney viscosity MS₁₊₄(100° C.) of the natural rubber can be 50 or less, 40 or less, or even 30 or less. The Mooney viscosity MS₁₊₄(100° C.) can be adjusted by a general method such as mastication.

The acrylic monomer can be added onto the natural rubber in the presence of a radical polymerization initiator. Examples of the radical polymerization initiator include general peroxide-based initiators, azo-based initiators, and a redox-based initiator by combination of a peroxide and a reducing agent. These can be used singly as one species or in a combination of two or more species. Among them, a peroxide-based initiator is preferable. Examples of the peroxide-based initiator include diacyl peroxides such as aromatic diacyl peroxides typified by benzoyl peroxide (BPO) and aliphatic diacyl peroxides such as dialkyloyl peroxides (e.g. dilauroyl peroxide). Other examples of the peroxide-based initiator include t-butyl hydroperoxide, di-t-butyl peroxide, t-butyl peroxybenzoate, dicumyl peroxide, 1,1-bis(t-butylperoxy)-3,3,5-trimethylcyclohexane, and 1,1-bis(t-butylperoxy)cyclododecane. For the peroxide-based initiator, solely one species or a combination of two or more species can be used.

The base polymer of the PSA may consist of one, two or more species of acrylate-modified natural rubbers, or it may comprise an acrylate-modified natural rubber and other polymer(s) together. The ratio of the acrylate-modified natural rubber to the entire base polymer is not particularly limited. It can be suitably selected in the range above 0% by weight and below 100% by weight. In some embodiments, the acrylate-modified natural rubber content can be, for instance, 10% by weight or higher. From the standpoint of achieving adhesive strength to both a high-polar adherend and a low-polar adherend, good holding properties (e.g. high shear bonding strength), it is advantageously 25% by weight or higher, or preferably 40% by weight or higher. In some embodiments, the acrylate-modified natural rubber content can be above 50% by weight, 65% by weight or higher, 80% by weight or higher, or even 90% by weight or higher. It is noted that when an acrylate-modified natural rubber is used solely as the base polymer, the acrylate-modified natural rubber accounts for 100% by weight of the entire base polymer.

From the standpoint of the miscibility, as the polymer used together with the acrylate-modified natural rubber, for instance, a rubber-based polymer can be preferably used. As the rubber-based polymer, either a natural rubber or a synthetic rubber (e.g. styrene-butadiene rubber, styrene-butadiene block copolymer, styrene-isobutylene block copolymer, etc.) can be used. From the standpoint of increasing the biomass carbon ratio, it is particularly preferable to use a natural rubber which is a biomass material. The base polymer may consist of an acrylate-modified natural rubber and a natural rubber, or it may include an acrylate-modified natural rubber, a natural rubber and other polymer(s) altogether. In some embodiments, besides the acrylate-modified natural rubber and the natural rubber, the other polymer content is suitably below 30% by weight of the entire base polymer, preferably below 20% by weight, or possibly below 10% by weight (e.g. below 3% by weight). The art disclosed herein can be practiced in an embodiment comprising, as the base polymer, no other polymer besides the acrylate-modified natural rubber and the natural rubber.

When using a natural rubber, the ratio of the natural rubber to the total amount of the acrylate-modified natural rubber and natural rubber can be above 0% by weight. For instance, it can be 5% by weight or higher, 10% by weight or higher, 25% by weight or higher, or even 40% by weight or higher. With increasing ratio of natural rubber, the biomass carbon ratio of the PSA tends to increase. The ratio of the natural rubber to the total amount of the acrylate-modified natural rubber and natural rubber can be below 100% by weight; it can also be 95% by weight or lower, 75% by weight or lower, or even 60% by weight or lower. From the standpoint of increasing the adhesive strength to high-polar and low-polar adherends, in some embodiments, the natural rubber can be used in an amount of 50% by weight or less, 45% by weight or less, 35% by weight or less, 25% by weight or less, less than 20% by weight, or even less than 20% by weight (e.g. less than 3% by weight). The art disclosed herein can be practiced in an embodiment free of a natural rubber as the base polymer.

Other polymers that can be used in combination with the acrylate-modified natural rubber include an acrylic polymer and a polyester-based polymer. The acrylic polymer may be formed from a monomer mixture comprising a monomer having biomass-derived carbons. A preferable polyester-based polymer is formed from a polycarboxylic acid (typically a dicarboxylic acid) and a polyol (typically a diol) of which at least one is a compound comprising partially or entirely biomass-derived carbons, for instance, a plant-derived from a plant-derived unsaturated fatty acid (sebacic acid, oleic acid, erucic acid, etc.) can be used. As the biomass-derived diol, for instance, a dimeric diol obtainable by reduction of the dimeric acid, biomass ethylene glycol obtainable from biomass ethanol as the starting material, or the like can be used. Such a polyester-based polymer may have a biomass carbon ratio of, for instance, above 40%, preferably above 50%, 70% or higher, 85% or higher, 90% or higher, or even 100%. From the standpoint of the miscibility, etc., the polyester-based polymer content is suitably less than 20% by weight of the entire base polymer, preferably less than 10% by weight, or possibly even less than 5% by weight.

### (Crosslinking Agent)

In the PSA layer of the PSA sheet disclosed herein, a crosslinking agent is preferably used. The crosslinking agent may contribute to an increase in cohesive strength of the PSA. The crosslinking agent can be selected among various crosslinking agents known in the field of PSA. Examples of the crosslinking agent include isocyanate-based crosslinking agent, epoxy-based crosslinking agent, oxazoline-based crosslinking agent, aziridine-based crosslinking agent, melamine-based crosslinking agent, peroxide-based crosslinking agent, urea-based crosslinking agent, metal alkoxide-based crosslinking agent, metal chelate-based crosslinking agent, metal salt-based crosslinking agent, carbodiimide-based crosslinking agent, and amine-based crosslinking agent. As the crosslinking agent, solely one species or a combination of two or more species can be used.

When using a crosslinking agent, the amount used is not particularly limited. The amount of crosslinking agent used to 100 parts by weight of base polymer can be selected from a range of, for instance, 0.001 part to 15 parts by weight. From the standpoint of obtaining an increase in cohesive strength and tight adhesion to adherend in a well-balanced manner, the amount of crosslinking agent used to 100 parts by weight of base polymer is preferably 12 parts by weight or less, possibly 8 parts by weight or less, or 6 parts by weight or less; it is suitably 0.005 part by weight or greater, or possibly 0.01 part by weight or greater.

The crosslinking agent is preferably selected among sulfur-free crosslinking agents. Here, the sulfur-free crosslinking agent means a crosslinking agent that is at least free of intentionally-added sulfur (S) and the concept of this material is clearly distinct from a vulcanizer which is generally used as a crosslinking agent for natural rubber. A crosslinking agent whose active ingredient is a compound free of sulfur as a constituent is a typical example of the sulfur-free crosslinking agent referred to here. The sulfur-free crosslinking agent is used as the crosslinking agent to avoid incorporation of sulfur from the crosslinking agent into the PSA layer. This can be an advantageous feature in a PSA sheet used in the field of electronic devices for which the presence of sulfur is undesirable. In the PSA sheet disclosed herein, it is preferable that no vulcanizer is used in the PSA layer.

In some embodiments, the crosslinking agent preferably comprises at least an isocyanate-based crosslinking agent. As the isocyanate-based crosslinking agent, solely one species or a combination of two or more species can be used. The isocyanate-based crosslinking agent can also be used in combination with other crosslinking agent(s), for instance, an epoxy-based crosslinking agent.

As the isocyanate-based crosslinking agent, a polyisocyanate-based crosslinking agent having at least two isocyanate groups per molecule is preferably used. The number of isocyanate groups per molecule of polyisocyanate-based crosslinking agent is preferably 2 to 10, for instance, 2 to 4, or typically 2 or 3. Examples of the polyisocyanate-based crosslinking agent include aromatic polyisocyanates such as tolylene diisocyanate and xylene diisocyanate; alicyclic isocyanates such as isophorone diisocyanate; and aliphatic polyisocyanates such as hexamethylene diisocyanate. More specific examples include lower aliphatic polyisocyanates such as butylene diisocyanate and hexamethylene diisocyanate; alicyclic polyisocyanates such as cyclopentylene diisocyanate, cyclohexylene diisocyanate and isophorone diisocyanate; aromatic diisocyanates such as 2,4-tolylene diisocyanate, 4,4′-diphenylmethane diisocyanate, xylylene diisocyanate and polymethylene polyphenyl isocyanate; isocyanate adducts such as trimethylolpropane-tolylene diisocyanate trimer adduct (product name CORONATE L available from Tosoh Corporation), a trimethylolpropane-hexamethylene diisocyanate trimer adduct (product name CORONATE HL available from Tosoh Corporation), and isocyanurate of hexamethylene diisocyanate (product name CORONATE HX available from Tosoh Corporation); polyisocyanates such as polyether polyisocyanate and polyester polyisocyanate; adducts of these polyisocyanates and various polyols; and polyisocyanates polyfunctionalized with isocyanurate bonds, biuret bonds, allophanate bonds, etc.

When using an isocyanate-based crosslinking agent, relative to 100 parts by weight of base polymer, it can be used in an amount of, for instance, about 0.1 part by weight or greater, 0.5 part by weight or greater, 1.0 part by weight or greater, or even greater than 1.5 parts by weight. From the standpoint of obtaining greater effects of its use, the amount of isocyanate-based crosslinking agent used to 100 parts by weight of base polymer can be, for instance, greater than 2.0 parts by weight, 2.5 parts by weight or greater, or even 2.7 parts by weight or greater. The amount of isocyanate-based crosslinking agent used to 100 parts by weight of base polymer is suitably 10 parts by weight or less, possibly 7 parts by weight or less, or even 5 parts by weight or less. From the standpoint of avoiding a decrease in tightness of adhesion to adherend caused by excessive crosslinking, it may be advantageous to not use an excessive amount of isocyanate-based crosslinking agent.

As the epoxy-based crosslinking agent, a polyfunctional epoxy compound having at least two epoxy groups per molecule can be used. Examples include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl)isocyanurate, resorcine diglycidyl ether, bisphenol-S-diglycidyl ether and an epoxy-based resin having at least two epoxy groups per molecule. Examples of commercial epoxy-based crosslinking agents include TETRAD C and TETRAD X available from Mitsubishi Gas Chemical, Inc.

When using an epoxy-based crosslinking agent, relative to 100 parts by weight of base polymer, it can be used in an amount of, for instance, about 0.005 part by weight or greater; or from the standpoint of obtaining greater effects of its use, 0.01 part by weight or greater, or even 0.02 part by weight or greater. The amount of epoxy-based crosslinking agent used to 100 parts by weight of base polymer is suitably 2 parts by weight or less, possibly 1 part by weight or less, 0.5 part by weight or less, or even 0.1 part by weight or less. From the standpoint of avoiding a decrease in tightness of adhesion to adherend caused by excessive crosslinking, it may be advantageous to not use an excessive amount of epoxy-based crosslinking agent.

When using an isocyanate-based crosslinking agent and a different crosslinking agent (i.e. non-isocyanate-based crosslinking agent) together, the relative amounts of the isocyanate-based crosslinking agent and non-isocyanate-based crosslinking agent (e.g. an epoxy-based crosslinking agent) are not particularly limited. From the standpoint of favorably combining tight adhesion to adherend and cohesive strength, in some embodiments, the non-isocyanate-based crosslinking agent content can be, by weight, about ½ of the isocyanate-based crosslinking agent content or less, about ⅕ or less, about 1/10 or less, about 1/20 or less, or even about 1/30 or less. From the standpoint of favorably obtaining the effects of the combined use of isocyanate-based crosslinking agent and non-isocyanate-based crosslinking agent (e.g. an epoxy-based crosslinking agent), the non-isocyanate-based crosslinking agent content is suitably about 1/1000 of the isocyanate-based crosslinking agent content or greater, for instance, about 1/500 or greater.

To efficiently carry out the crosslinking reaction by an aforementioned crosslinking agent, a crosslinking catalyst can also be used. As the crosslinking catalyst, for instance, a tin-based catalyst can be preferably used such as dioctyltin dilaurate. The amount of crosslinking catalyst used is not particularly limited. For instance, to 100 parts by weight of base polymer, it can be about 0.0001 part to 1 part by weight.

Another example of the crosslinking agent that can be used in the PSA layer of the PSA sheet disclosed herein is a monomer having two or more polymerizable functional groups per molecule, that is, a polyfunctional monomer. Examples of the polyfunctional monomer include ethylene glycol di(meth)acrylate, propylene glycol di(meth)acrylate, polyethylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, ethyleneglycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate, butanediol (meth)acrylate and hexanediol (meth)acrylate.

When using a polyfunctional monomer as the crosslinking agent, its amount used will depend on its molecular weight, the number of functional groups therein, etc. It is suitably in a range of about 0.01 part to 3.0 parts by weight to 100 parts by weight of base polymer. In some embodiments, from the standpoint of obtaining greater effects, the amount of polyfunctional monomer used to 100 parts by weight of base polymer can be, for instance, 0.02 part by weight or greater, or even 0.03 part by weight or greater. On the other hand, from the standpoint of avoiding a decrease in tack caused by an excessive increase in cohesive strength, the amount of polyfunctional monomer used to 100 parts by weight of base polymer can be 2.0 parts by weight or less, 1.0 part by weight or less, or even 0.5 part by weight or less.

The PSA layer in the PSA sheet disclosed herein may be subjected to electron beam crosslinking (a crosslinking treatment by electron beam irradiation) for the purpose of increasing the cohesive strength, etc. The electron beam-induced crosslinking can be carried out in place of or in combination with the use of an aforementioned crosslinking agent.

### (Tackifier)

The PSA in the art disclosed herein may have a composition that includes a tackifier (typically a tackifier resin). With the use of tackifier, the adhesive strength can be preferably increased. The tackifier is not particularly limited. For instance, various tackifier resins can be used, such as rosin-based tackifier resins, terpene-based tackifier resins, phenolic tackifier resins and hydrocarbon-based tackifier resins. These tackifiers can be used singly as one species or in a combination of two or more species.

In some preferable embodiments, the PSA layer comprises one, two or more species of tackifier resin selected among rosin-based tackifier resins and terpene-based tackifier resins. This can preferably bring about high adhesive strength to both a high-polar adherend and a low-polar adherend. As the tackifier T1, one, two or more species of rosin-based tackifier resin are used in an embodiment; one, two or more species of terpene-based tackifier resin are used in an embodiment; and one, two or more species of rosin-based tackifier resin and one, two or more species of terpene-based tackifier resin are used in an embodiment. In particular, a terpene-based tackifier resin is preferably used.

Specific examples of the rosin-based tackifier resin include unmodified rosins (raw rosins) such as gum rosin, wood rosin and tall-oil rosin; modified rosins (hydrogenated rosins, disproportionated rosins, polymerized rosins, other chemically-modified rosins, etc.) obtainable by subjecting these unmodified rosins to modifications such as hydrogenation, disproportionation and polymerization; and various other rosin derivatives. Examples of the rosin derivatives include rosin esters such as rosin esters obtainable by esterifying unmodified rosins with alcohols (i.e. esterified rosins) and modified rosin esters obtainable by esterifying modified rosins (hydrogenated rosins, disproportionated rosins, polymerized rosins, etc.) with alcohols (i.e. esterified modified rosins); unsaturated fatty acid-modified rosins obtainable by modifying unmodified rosins or modified rosins (hydrogenated rosins, disproportionated rosins, polymerized rosins, etc.) with unsaturated fatty acids; unsaturated fatty acid-modified rosin esters obtainable by modifying rosin esters with unsaturated fatty acids; rosin alcohols obtainable by reduction of carboxy groups in unmodified rosins, modified rosins (hydrogenated rosins, disproportionated rosins, polymerized rosins, etc.), unsaturated fatty acid-modified rosins, or unsaturated fatty acid-modified rosin esters; and metal salts of rosins such as unmodified rosins, modified rosins and various rosin derivatives (especially rosin esters). It is noted that, in this description, so-called rosin phenol resins having phenol structures are classified not as rosin-based tackifier resins, but as phenolic tackifier resins.

Examples of the terpene-based tackifier resin include terpenes (typically monoterpenes) such as α-pinene, β-pinene, d-limonene, l-limonene, dipentene, etc. It can be a homopolymer of one species of terpene or a copolymer of two or more species of terpene. Examples of the homopolymer of one species of terpene include α-pinene polymer, β-pinene polymer and dipentene polymer. Other examples of the terpene-based tackifier resin include resins obtainable by modifying the terpene resins. Specific examples include styrene-modified terpene resins and hydrogenated terpene resins. In this description, however, a species considered as a terpene-phenol resin or as a hydrogenated terpene-phenol resin is treated not as a modified terpene resin, but as a phenolic tackifier resin.

The softening point (softening temperature) of the tackifier T1 is not particularly limited. It is preferable to use a tackifier resin having a softening point of about 60° C. or higher (preferably about 80° C. or higher, more preferably about 95° C. or higher, e.g. about 105° C. or higher). With such a tackifier resin, a PSA sheet of higher performance (e.g. higher adhesive strength) can be obtained. The maximum softening point of the tackifier T1 is not particularly limited. From the standpoint of the balance among adhesive properties, miscibility, etc., in some embodiments, the tackifier T1 has a softening point of suitably about 200° C. or lower, preferably about 180° C. or lower, for instance, possibly about 140° C. or lower, or even about 120° C. or lower. When a tackifier T1 having a softening point in these ranges is selected and used, it is possible to preferably obtain a PSA that shows excellent adhesive strength to both a high-polar adherend and a low-polar adherend. When two or more species of tackifier T1 are used, the tackifier T1's softening point is determined from the sum of the products of the weight fractions (relative to the total amount of tackifier T1) and the softening points of the respective tackifiers considered as the tackifier T1.

The softening point of a tackifier (typically a tackifier resin) here is defined as the value determined by the softening point test method (ring and ball method) specified either in JIS K5902:2006 or in JIS K2207:2006.

The hydroxyl value of the tackifier T1 is not particularly limited. In view of increasing the adhesive strength and of the miscibility with the base polymer, it is suitably about 30 mgKOH/g or less, preferably below 10 mgKOH/g, for instance, below 3 mgKOH/g, or possibly below 1 mgKOH/g. In some embodiments, it is preferable to use a tackifier T1 in which hydroxyl groups are not detected. When two or more species of tackifier T1 are used, the tackifier T1's hydroxyl value is determined from the sum of the products of the weight fractions (relative to the total amount of tackifier T1) and the hydroxyl values of the respective tackifiers considered as the tackifier T1.

In this description, as the hydroxyl value of a tackifier, a value determined by the potentiometric titration method specified in JIS K0070:1992 can be used.

The amount of tackifier T1 to be included is selected to obtain high adhesive strength to high-polar and low-polar adherends and is not particularly limited to a specific range. The tackifier T1 content is suitably, for instance, greater than 50 parts by weight to 100 parts by weight of the base polymer. From the standpoint of increasing the adhesive strength, the tackifier T1 content relative to 100 parts by weight of the base polymer is preferably about 55 parts by weight or greater, more preferably about 60 parts by weight or greater, yet more preferably about 65 parts by weight or greater (e.g. about 70 parts by weight or greater), or possibly even about 80 parts by weight or greater (e.g. about 90 parts by weight or greater). In view of the balance among adhesive properties, in some embodiments, the tackifier T1 content relative to 100 parts by weight of the base polymer is about 200 parts by weight or less, suitably about 150 parts by weight or less, preferably 120 parts by weight or less, possibly about 100 parts by weight or less (typically less than 100 parts by weight), about 90 parts by weight or less, or even about 80 parts by weight or less (e.g. about 75 parts by weight or less). When the tackifier T1 content is selected in these ranges, excellent adhesive strength can be preferably obtained.

In some preferable embodiments, the PSA layer comprises a phenolic tackifier resin as the tackifier T2. This can preferably bring about excellent adhesive strength to both high-polar and low-polar adherends. For instance, in an embodiment using tackifiers T1 and T2 together, the PSA is provided with a property (polarity, etc) different from those of the tackifier T1 and this is presumed to work to increase the adhesive strength to both high-polar and low-polar adherends. It is noted that the art disclosed herein is not limited to this interpretation. In particular, the phenolic tackifier resin refers to a tackifier resin having a phenol structure and it can be called a phenol group-containing tackifier resin as well. Examples of the phenolic tackifier resin include terpene-phenol resins, hydrogenated terpene-phenol resins, alkylphenol resins and rosin-phenol resins. For the phenolic tackifier resin, solely one species or a combination of two or more species can be used. In particular, rosin-phenol resins and terpene-phenol resins are preferable; and terpene-phenol resins (terpene-phenolic tackifier resins) are more preferable. In an embodiment using tackifiers T1 and T2 together, it is particularly preferable to use a terpene-based tackifier resin as the tackifier T1 and a terpene-phenolic tackifier resin as the tackifier T2 in combination.

The terpene phenol resin refers to a polymer comprising a terpene residue and a phenol residue and the concept encompasses both a copolymer of a terpene and a phenol compound (terpene-phenol copolymer resin) and a phenol-modified terpene homopolymer or copolymer (phenol-modified terpene resin). Preferable examples of terpenes forming such terpene-phenol resins include the aforementioned monoterpenes. The hydrogenated terpene-phenol resin has a structure obtained by hydrogenating such a terpene-phenol resin. This may be called a hydrogen-added terpene-phenol resin.

The alkylphenol resin is a resin (oil-phenol resin) obtainable from an alkylphenol and formaldehyde. Examples of the alkylphenol resin include novolacs and resoles.

Rosin-phenol resins are typically phenol-modified products of rosins or the aforementioned various rosin derivatives (including rosin esters, unsaturated fatty acid-modified rosins, and unsaturated fatty acid-modified rosin esters). Examples of the rosin-phenol resin include rosin-phenol resins obtainable by a method where a phenol is added to a rosin or one of the aforementioned rosin derivatives in the presence of an acid catalyst and thermally polymerized, and like method. As the rosin-phenol resin in the art disclosed herein, for instance, a phenol-modified rosin ester (rosin ester-phenol resin) can be preferably used.

The softening point of the tackifier T2 is not particularly limited and it is suitably about 60° C. or higher (e.g. about 80° C. or higher). From the standpoint of increasing the adhesive strength, it is preferably about 100° C. or higher, more preferably about 110° C. or higher, yet more preferably about 120° C. or higher (e.g. about 125° C. or higher), particularly preferably about 130° C. or higher (e.g. about 135° C. or higher), or possibly even about 140° C. or higher (e.g. 145° C. or higher). The maximum softening point of the tackifier T2 is not particularly limited. From the standpoint of the adhesive properties, miscibility, etc., in some embodiments, the tackifier T2 has a softening point of suitably about 200° C. or lower, preferably about 180° C. or lower, for instance, about 160° C. or lower, or possibly even about 140° C. or lower. When a tackifier T2 having a softening point in these ranges is selected and used, it is possible to preferably obtain a PSA that shows excellent adhesive strength to both a high-polar adherend and a low-polar adherend. When two or more species of tackifier T2 are used, the tackifier T2's softening point is determined from the sum of the products of the weight fractions (relative to the total amount of tackifier T2) and the softening points of the respective tackifiers considered as the tackifier T2.

The tackifier T2 is not particularly limited to a specific range of hydroxyl values and has hydroxyl groups in a suitable amount to bring about high adhesive strength to both high-polar and low-polar adherends. The tackifier T2 has a hydroxyl value of, for instance, greater than 0 mgKOH/g, suitably about 1 mgKOH/g or greater, or possibly about 10 mgKOH/g or greater (e.g. about 30 mgKOH/g or greater, or even about 50 mgKOH/g or greater). The maximum hydroxyl value of the tackifier T2 is not particularly limited. From the standpoint of the miscibility with the base polymer, etc., the tackifier T2 has a hydroxyl value of suitably about 350 mgKOH/g or less, preferably about 300 mgKOH/g or less, more preferably about 200 mgKOH/g or less, or yet more preferably about 160 mgKOH/g or less (e.g. about 120 mgKOH/g or less).

In an embodiment using two or more species of tackifier T2, from the standpoint of increasing the adhesive strength to both high-polar and low-polar adherends, it is preferable to use, as the tackifier T2, a tackifier resin (T2_{HV1}) having a hydroxyl value of 80 mgKOH/g or greater and a tackifier resin (T2_{HV2}) having a hydroxyl value of 0 or greater and 80 mgKOH/g or less in combination. In some embodiments, the tackifier resin T2_{HV1} may have a hydroxyl value of about 90 mgKOH/g or greater. The maximum hydroxyl value of the tackifier resin T2_{HV1} is not particularly limited. It is suitably about 350 mgKOH/g or less, preferably about 300 mgKOH/g or less, or more preferably about 200 mgKOH/g or less (typically about 160 mgKOH/g or less, e.g. about 140 mgKOH/g or less). The hydroxyl value of the tackifier resin T2_{HV2} is suitably about 1 mgKOH/g or greater, or preferably about 30 mgKOH/g or greater (e.g. about 50 mgKOH/g or greater). The maximum hydroxyl value of the tackifier resin T2_{HV2} can also be, for instance, below 70 mgKOH/g.

In an embodiment where a tackifier resin (T2_{HV1}) having a hydroxyl value of 80 mgKOH/g or greater and a tackifier resin (T2_{HV2}) having a hydroxyl value of 0 or greater and below 80 mgKOH/g are used together as the tackifier T2, the amounts of T2_{HV1} and T2_{HV2} are not particularly limited to meet a certain relationship. Their amounts can be selected so that, for instance, the weight ratio (T2_{HV1}:T2_{HV2}) is in the range of 1:5 to 5:1, or suitably in the range of about 1:3 to 3:1 (e.g. 1:2 to 2:1).

The amount of tackifier T2 to be included is selected to obtain high adhesive strength to high-polar and low-polar adherends and is not particularly limited to a specific range. For instance, it is suitably, for instance, about 1 part by weight or greater (about 3 parts by weight or greater) to 100 parts by weight of the base polymer. From the standpoint of increasing the adhesive strength to both high-polar and low-polar adherends, the tackifier T2 content relative to 100 parts by weight of the base polymer is preferably about 5 parts by weight or greater, more preferably about 10 parts by weight or greater, or yet more preferably about 15 parts by weight or greater (e.g. about 20 parts by weight or greater). In view of the balance among adhesive properties and of the miscibility, etc., in some embodiments, the tackifier T2 content relative to 100 parts by weight of the base polymer is suitably less than about 30 parts by weight, or preferably about 25 parts by weight or less (e.g. about 22 parts by weight or less). When the tackifier T2 content is selected in these ranges, it is possible to preferably obtain a PSA showing excellent adhesive strength to both high-polar and low-polar adherends.

In an embodiment using tackifiers T1 and T2 together, the relationship between the softening points SP1 (° C.) and SP2 (° C.) of tackifiers T1 and T2 is not particularly limited. It is possible to carry out any among an embodiment where the softening point SP1 is higher than the softening point SP2 (SP1>SP2), an embodiment where the softening point SP1 is similar to the softening point SP2 (SP1≈SP2), and an embodiment where the softening point SP2 is higher than the softening point SP1 (SP2>SP1). Some preferable embodiment can be implemented in an embodiment where the softening point SP2 is higher than the softening point SP1 (SP2>SP1). In addition to the effect of the tackifier T1 to increase the adhesive strength, this tends to preferably bring about the effect of the added tackifier T2. In such an embodiment, between the softening points SP1 and SP2, the difference (SP2−SP1) is not particularly limited to a specific range. The difference is suitably about 5° C. or greater, preferably about 10° C. or greater, more preferably about 15° C. or greater, yet more preferably about 20° C. or greater, particularly preferably about 25° C. or greater (e.g. about 30° C. or greater), or possibly even about 35° C. or greater. The difference (SP2−SP1) is, for instance, suitably about 80° C. or less, or possibly even about 50° C. or less (e.g. about 40° C. or less).

In an embodiment using tackifiers T1 and T2 together, the ratio (A2/A1) of the weight fraction A1 of tackifier T1 to the weight fraction A2 of tackifier T2 is selected to bring about high adhesive strength to both high-polar and low-polar adherends; and the ratio is not limited to a certain range. From the standpoint of preferably obtain the effect of the combined use of tackifiers T1 and T2 (particularly the effect of T2 addition), for instance, the A2/A1 ratio is suitably about 0.01 or higher, preferably about 0.05 or higher, more preferably about 0.10 or higher, yet more preferably about 0.20 or higher, or particularly preferably about 0.25 or higher (e.g. above 0.25). From the standpoint of the miscibility, the balance of adhesive strength to high-polar and low-polar adherends, etc., the maximum A2/A1 ratio is suitably lower than 0.75 (e.g. below 0.50), preferably lower than 0.40, or more preferably lower than 0.35 (e.g. below 0.30). When the A2/A1 ratio is selected in these ranges, it is possible to preferably obtain a PSA showing excellent adhesive strength to both high-polar and low-polar adherends.

In an embodiment using tackifiers T1 and T2 together, the combined amount of tackifiers T1 and T2 is selected to bring about high adhesive strength to high-polar and low-polar adherends without particular limitations. From the standpoint of increasing the adhesive strength, the combined amount of tackifiers T1 and T2 is, for instance, suitably greater than 50 parts by weight to 100 parts by weight of the base polymer, preferably greater than 70 parts by weight, more preferably about 80 parts by weight or greater (e.g. greater than 80 parts by weight), or possibly even 85 parts by weight. In view of the balance among adhesive properties and of the miscibility, etc., in some embodiments, the combined amount of tackifiers T1 and T2 relative to 100 parts by weight of the base polymer is about 220 parts by weight or less (e.g. about 170 parts by weight or less), suitably about 140 parts by weight or less (about 120 parts by weight or less), preferably about 100 parts by weight or less (typically less than 100 parts by weight), or possibly even about 95 parts by weight or less (e.g. about 90 parts by weight or less). When the combined amount of tackifiers T1 and T2 is selected in these ranges, it is possible to preferably obtain a PSA showing excellent adhesive strength to both high-polar and low-polar adherends.

The PSA layer of the PSA sheet disclosed herein may comprise one, two or more species of tackifier T3 different from the tackifiers T1 and T2. The PSA layer may include the tackifier T3 in addition to the tackifier T1 and/or T2 or may include solely the tackifier T3 as the tackifier. Examples of the tackifier T3 include hydrocarbon-based tackifier resins. The tackifier T3 is not particularly limited in softening point or in hydroxyl value. A tackifier possibly used has suitable softening point and hydroxyl value in accordance with the application and target properties.

Examples of the hydrocarbon-based tackifier resin include various hydrocarbon resins such as aliphatic hydrocarbon resins, aromatic hydrocarbon resins, aliphatic cyclic hydrocarbon resins, aliphatic/aromatic petroleum resins (styrene-olefin copolymers and the like), aliphatic/alicyclic petroleum resins, hydrogenated hydrocarbon resin, coumarone resins, and coumarone indene resins.

Examples of the aliphatic hydrocarbon resins include polymers of one, two or more species of aliphatic hydrocarbons selected among olefins and dienes having about 4 to 5 carbon atoms. Examples of the olefin include 1-butene, isobutylene and 1-pentene. Examples of the diene include butadiene, 1,3-pentadiene and isoprene.

Examples of the aromatic hydrocarbon resins include polymers of vinyl-group-containing aromatic hydrocarbons (styrene, vinyl toluene, a-methyl styrene, indene, methyl indene, etc.) having 8 to 10 carbon atoms. Examples of the alicyclic hydrocarbon resins include alicyclic hydrocarbon-based resins obtainable by polymerization of cyclic dimers of so-called “C4 petroleum fractions” and “C5 petroleum fractions”; polymers of cyclic diene compounds (cyclopentadiene, dicyclopentadiene, ethylidene norbornene, dipentene, etc.) or hydrogenation products of these polymers; and alicyclic hydrocarbon-based resins obtainable by hydrogenation of aromatic rings in aromatic hydrocarbon resins or aliphatic-aromatic petroleum resins.

When the PSA layer disclosed herein includes a tackifier, from the standpoint of increasing the biomass carbon ratio of the PSA layer, it is preferable to use a tackifier derived from a plant (i.e. a plant-based tackifier) as the tackifier. Examples of the plant-based tackifier include the aforementioned rosin-based tackifier resins and terpene-based tackifier resins. The plant-based tackifiers can be used singly as one species or in a combination of two or more species. When the PSA layer disclosed herein includes a tackifier, the ratio of plant-based tackifier to the total amount of tackifier is preferably 30% by weight or higher (e.g. 50% by weight or higher, typically 80% by weight or higher). In a particularly preferable embodiment, the ratio of plant-based tackifier to the total amount of tackifier is 90% by weight or higher (e.g. 95% by weight or higher, typically 99% to 100% by weight). The art disclosed herein can be preferably implemented in an embodiment essentially free of a non-plant-based tackifier.

There are no particular limitations to the softening point of the tackifier that can be used in the art disclosed herein (when two or more species of tackifier are used, the average softening point determined based on the sum of the products of the weight fractions and the softening points of the respective tackifiers). It may be preferable to use a tackifier having a softening point of about 60° C. or higher (preferably about 80° C. or higher, more preferably about 95° C. or higher, e.g. about 105° C. or higher). Such a tackifier can bring about a PSA sheet having superior properties (e.g. high adhesive strength). The maximum softening point of the tackifier is not particularly limited. In some embodiments, from the standpoint of the adhesive properties and miscibility, etc., the tackifier can have a softening point of about 200° C. or lower, preferably about 180° C. or lower, more preferably about 160° C. or lower, or even about 140° C. or lower.

The total tackifier content is selected to bring about high adhesive strength to high-polar and low-polar adherends without particular limitations. From the standpoint of increasing the adhesive strength, the total tackifier content is, for instance, suitably about 50 parts by weight or greater to 100 parts by weight of the base polymer, preferably about 70 parts by weight or greater, more preferably about 80 parts by weight or greater (e.g. greater than 80 parts by weight), or yet more preferably about 85 parts by weight or greater. In view of the balance among adhesive properties and of the miscibility, in some embodiments, the total tackifier content relative to 100 parts by weight of the base polymer is about 220 parts by weight or less (e.g. about 170 parts by weight or less), suitably about 140 parts by weight or less (about 120 parts by weight or less), preferably about 100 parts by weight or less (typically less than 100 parts by weight), or possibly even about 95 parts by weight or less (e.g. about 90 parts by weight or less).

(Other components)

Th PSA layer may include various additives generally known in the field of PSA compositions as necessary, such as a leveling agent, plasticizer, filler, colorant (pigment, dye, etc.), antistatic agent, anti-aging agent, UV absorber, antioxidant and photo-stabilizer. As for these various additives, heretofore known species can be used by typical methods.

The filler content in the PSA layer can be, for instance, 0 part by weight or greater and 200 parts by weight or less (preferably 100 parts by weight or less, e.g. 50 parts by weight or less) relative to 100 parts by weight of base polymer. From the standpoint of preventing the filler from falling out of the PSA layer, in some embodiment, the filler content relative to 100 parts by weight of base polymer is suitably less than 30 parts by weight, preferably less than 20 parts by weight, more preferably less than 10 parts by weight, possibly less than 5 parts by weight, or even less than 1 part by weight. The PSA layer may be free of any filler.

The plasticizer content in the PSA layer can be, for instance, 0 part by weight or greater and 35 parts by weight or less relative to 100 parts by weight of base polymer. From the standpoint of obtaining higher adhesive strength, the plasticizer content is preferably 25 parts by weight or less, or more preferably 15 parts by weight or less. From the standpoint of reducing the amount of possible volatile(s) arising from the plasticizer, in some embodiments, the plasticizer content relative to 100 parts by weight of base polymer is suitably less than 10 parts by weight, possibly less than 5 parts by weight, less than 3 parts by weight, or even less than 1 part by weight. The PSA layer may be essentially free of a plasticizer. For instance, when the PSA sheet is for internal use in an electronic device or for use in a precision electronic instrument, it is advantageous to reduce the plasticizer content or to not use any plasticizer.

In the PSA layer, it is preferable that neither vulcanizer nor sulfur containing vulcanization accelerator (thiuram-based vulcanization accelerator, dithiocarbamate-based vulcanization accelerator, thiazole-based vulcanization accelerator, etc.) is used. This can be an advantageous feature as a PSA sheet used in the field of electronic devices for which the presence of sulfur is undesirable. In the PSA layer of the PSA sheet disclosed herein, it is preferable to avoid the use of any sulfur-containing material, not just vulcanizers and vulcanization accelerators.

The PSA layer (layer formed of PSA) in the PSA sheet disclosed herein can be formed from a PSA composition having such a composition. The form of PSA composition is not particularly limited. For instance, it can be an aqueous PSA composition, solvent-based PSA composition, hot-melt PSA composition, or active energy ray-curable PSA composition. Here, the aqueous PSA composition refers to a PSA composition comprising a PSA (PSA layer-forming components) in a solvent (an aqueous solvent) primarily comprising water and the concept encompasses a water-dispersed PSA composition in which the PSA is dispersed in water and a water-soluble PSA composition in which the PSA is dissolved in water. The solvent-based PSA composition refers to a PSA composition comprising a PSA in an organic solvent. The PSA sheet disclosed herein can be preferably made in an embodiment having a PSA layer formed from a solvent-based PSA composition.

The PSA layer disclosed herein can be formed from a PSA composition by a heretofore known method. For instance, with respect to a PSA sheet without substrate, the PSA sheet can be formed by applying a PSA composition to a releasable surface (release face) and allowing the PSA composition to cure to form a PSA layer on the surface. As for a substrate-supported PSA sheet, it is preferable to employ a method (direct method) for forming a PSA layer where a PSA composition is directly provided (typically applied) to the substrate and allowed to cure. Alternatively, it is also possible to employ a method (transfer method) where a PSA composition is provided to a releasable surface (release face) and allowed to cure to form a PSA layer on the surface and the resulting PSA layer is transferred to a substrate. As the release face, the surface of a release liner, the substrate's backside that has been treated with release agent, or the like can be used. The PSA composition can be cured by subjecting the PSA composition to a curing process such as drying, crosslinking, polymerization, cooling, etc. Two or more different curing processes can be carried out at the same time or stepwise. The PSA layer disclosed herein is not limited to, but is typically formed in a continuous form. For instance, the PSA layer may be formed in a regular or random pattern of dots, stripes, etc.

The PSA composition can be applied, using a heretofore known coater, for instance, a gravure roll coater, reverse roll coater, kiss roll coater, clip roll coater, die coater, bar coater, knife coater and spray water. Alternatively, the PSA composition can be applied by immersion, curtain coating, etc.

From the standpoints of accelerating the crosslinking reaction, improving production efficiency, and the like, it is preferable to dry the PSA composition under heating. The drying temperature is possibly, for example, about 40° C. to 150° C. or preferably about 60° C. to 130° C. After drying the PSA composition, aging may be implemented for purposes such as adjusting the distribution or migration of components in the PSA layer, advancing the crosslinking reaction, and lessening possible strain in the substrate and the PSA layer.

In the PSA sheet disclosed herein, the thickness of the PSA layer is not particularly limited and can be suitably selected in accordance with the purpose. In view of the balance between adhesion to adherend and cohesion, the thickness of the PSA layer can be, for instance, about 2 μm to 500 μm. From the standpoint of the adhesion to adherend, the thickness of the PSA layer is suitably 3 μm or greater, or preferably 5 μm or greater. From the standpoint of obtaining higher adhesive strength, in some embodiments, the thickness of the PSA layer can be, for instance, 8 μm or greater, preferably 12 μm or greater, 15 μm or greater, 20 μm or greater, or even 25 μm or greater, 35 μm or greater, or even 45 μm or greater. From the standpoint of making the PSA sheet thinner, the thickness of the PSA layer can be, for instance, 200 μm or less, 150 μm or less, 100 μm or less, 70 μm or less, 50 μm or less, or even 30 μm or less. In an embodiment where thinning is of greater importance, the thickness of the PSA layer can be, for instance, 20 μm or less, 15 μm or less, or even 12 μm or less. When the PSA sheet disclosed herein is a double-faced PSA sheet having a PSA layer on each face of a substrate, the respective PSA layers may have the same thickness or different thicknesses.

### Substrate

The PSA sheet disclosed herein may be in a substrate-supported PSA sheet form having a PSA layer on one or each face of a substrate. As the substrate, various substrates in sheet forms can be used. For instance, resin film, paper, fabrics, rubber sheets, foam sheets, metal foil, a composite of these and the like can be used. For use in electronic devices, for instance, it is preferable to use a substrate that is less likely to form dust (e.g. fine fibers or particles such as paper dust). From such a standpoint, a preferable substrate is free of fibrous substances such as paper and fabrics. For instance, it is preferable to use resin film, a rubber sheet, a foam sheet, metal foil, a composite of these or the like.

Examples of the resin film include polyester films such as polyethylene terephthalate (PET) and polyethylene naphthalate; polyolefin films such as polyethylene (PE), polypropylene (PP), ethylene-propylene copolymer, and ethylene-butylene copolymer; vinyl chloride resin film; vinylidene chloride resin film; vinyl acetate resin film; polystyrene film; polyacetal film; polyimide film; polyamide film; fluororesin film; and cellophane. Examples of the rubber sheet include a natural rubber sheet and a butyl rubber sheet. Examples of the foam sheet include a polyurethane foam sheet and a polyolefin foam sheet. Examples of the metal foil include aluminum foil and copper foil. Among them, resin films are preferable from the standpoint of the size stability, thickness precision, cost, ease of processing, tensile strength, etc. As used herein, the “resin film” typically refers to a non-porous film and is conceptually distinct from so-called non-woven and woven fabrics.

In some embodiments, from the standpoint of the strength and the ease of processing, polyester film is preferably used as the substrate. As the polyester resin forming the polyester film, in typical, a polyester resin whose primary component is a polyester obtainable by polycondensation of a dicarboxylic acid and a diol is used.

Examples of the dicarboxylic acid forming the polyester include aromatic dicarboxylic acids such as phthalic acid, isophthalic acid, terephthalic acid, 2-methylterephthalic acid, 5-sulfoisophthalic acid, 4,4′-diphenyldicarboxylic acid, 4,4′- diphenyl ether dicarboxylic acid, 4,4′-diphenyl ketone dicarboxylic acid, 4,4′diphenoxyethane dicarboxylic acid, 4,4′-diphenylsulfone dicarboxylic acid, 1,4-naphthalene dicarboxylic acid, 1,5-naphthalene dicarboxylic acid, 2,6-naphthalene dicarboxylic acid and 2,7-naphthalene dicarboxylic acid; alicyclic dicarboxylic acids such as 1,2-cyclohexane dicarboxylic acid, 1,3-cyclohexane dicarboxylic acid, and 1,4-cyclohexane dicarboxylic acid; aliphatic dicarboxylic acids such as malonic acid, succinic acid, glutaric acid, adipic acid, pimelic acid, suberic acid, azelaic acid, sebacic acid, and dodecanoic acid; unsaturated dicarboxylic acids such as maleic acid, anhydrous maleic acid, and fumaric acid; and derivatives of these (e.g. lower alcohol esters of the dicarboxylic acids such as terephthalic acid, etc.). These can be used singly as one species or in a combination of two or more species.

Examples of the diol forming the polyester include aliphatic diols such as ethylene glycol, diethylene glycol, polyethylene glycol, propylene glycol, polypropylene glycol, 1,3-propanediol, 1,5-pentanediol, neopentyl glycol, 1,4-butanediol, 1,6-hexanediol, 1,8-octanediol, and polyoxytetramethylene glycol; alicyclic diols such as 1,2- cyclohexanediol, 1,4-cyclohexanediol, 1,1-cyclohexanedimethylol, and 1,4-cyclohexanedimethylol; and aromatic diols such as xylylene glycol, 4,4′-dihydroxybiphenyl, 2,2-bis(4′-hydroxyphenyl)propane, and bis(4-hydroxyphenyl)sulfone. These can be used singly as one species or in a combination of two or more species. From the standpoint of the transparency, etc., aliphatic diols are preferable and ethylene glycol is particularly preferable. The ratio of the aliphatic diol (preferably ethylene glycol) in the diol forming the polyester is preferably 50% by weight or higher (e.g. 80% by weight or higher, typically 95% by weight or higher). The diol may essentially consist of ethylene glycol. As the ethylene glycol, it is preferable to use biomass-derived ethylene glycol (typically biomass ethylene glycol obtained from biomass ethanol as the starting material). For instance, of the ethylene glycol forming the polyester, the ratio of biomass-derived ethylene glycol can be, for instance, 50% by weight or higher, preferably 75% by weight or higher, 90% by weight or higher, or even 95% by weight or higher. Essentially all of the ethylene glycol can be biomass-derived ethylene glycol.

Examples of the polyester resin film include polyethylene terephthalate (PET), polybutylene terephthalate (PBT), and polyethylene naphthalate (PEN).

When the substrate disclosed herein is a polyester film substrate, the polyester film substrate may include a non-polyester polymer in addition to the polyester. Favorable examples of the non-polyester polymer include those that are not polyester among the various polymer materials exemplified earlier as the resin film possibly forming the substrate. When the polyester film substrate disclosed herein includes a non-polyester polymer, the non-polyester polymer content is suitably less than 100 parts by weight to 100 parts by weight of polyester, preferably 50 parts by weight or less, more preferably 30 parts by weight or less, or yet more preferably 10 parts by weight or less. The non-polyester polymer content relative to 100 parts by weight of polyester can be 5 parts by weight or less, or even 1 part by weight or less. The art disclosed herein can be preferably implemented in an embodiment where, for instance, the polyester film substrate is 99.5% to 100% polyester by weight.

In some other embodiments, from the standpoint of the strength and flexibility, a polyolefin film can be preferably used as the substrate. The polyolefin film comprises, as the primary component, a polymer whose primary monomer (the primary component among the monomers) is an α-olefin. The ratio of the polymer is usually 50% by weight or higher (e.g. 80% by weight or higher, typically 90% to 100% by weight). Specific examples of the polyolefin include a species whose primary monomer is ethylene (i.e. polyethylene) and a species whose primary monomer is propylene (i.e. polypropylene). The polyethylene can be ethylene homopolymer, a copolymer of ethylene and other olefin(s) (e.g. one, two or more species selected among α-olefins with 3 to 10 carbon atoms), or a copolymer of ethylene and non-olefin monomer(s) (e.g. one, two or more species selected among ethylenically unsaturated monomers such as vinyl acetate, acrylic acid, methacrylic acid, methyl acrylate and ethyl acrylate). The polypropylene can be propylene homopolymer, a copolymer of propylene and other olefin(s) (e.g. one, two or more species selected among α-olefins with 2 or 4 to 10 carbon atoms), or a copolymer of propylene and non-olefin monomer(s). The substrate disclosed herein may consist of one species of polyolefin among these or may include two or more species of polyolefin.

When the substrate disclosed herein is a polyolefin film substrate, the polyolefin film substrate may include a non-polyolefin polymer in addition to the polyolefin(s). Favorable examples of the non-polyolefin polymer include those that are not polyolefins among the various polymer materials exemplified earlier as the resin film possibly forming the substrate. When the polyolefin film substrate disclosed herein includes a non-polyolefin polymer, the non-polyolefin polymer content is suitably less than 100 parts by weight to 100 parts by weight of polyolefin, preferably 50 parts by weight or less, more preferably 30 parts by weight or less, or yet more preferably 10 parts by weight or less. The non-polyolefin polymer content relative to 100 parts by weight of polyolefin can be 5 parts by weight or less, or even 1 part by weight or less. The art disclosed herein can be preferably implemented in an embodiment where, for instance, the polyolefin film substrate is 99.5% to 100% polyolefin by weight.

From the standpoint of reducing the usage of fossil-resource-based materials, the substrate disclosed herein preferably comprises a biomass material. The biomass material possibly forming the substrate is not particularly limited. Examples include biomass polyesters such as biomass PET and biomass polytrimethylene terephthalate (biomass PTT); polylactic acid; biomass polyolefins such as biomass polyethylenes including biomass high density polyethylene (biomass HDPE), biomass low density polyethylene (biomass LDPE) and biomass linear low density polyethylene (biomass LLDPE) as well as biomass polypropylene (biomass PP); biomass poly(3-hydroxybutyrate-co-3-hydroxyhexanoate); biomass polyamides such as polyhexamethylene sebacamide and poly(xylene sebacamide); biomass polyurethanes such as biomass polyester ether urethane and biomass polyether urethane; and cellulose-based resins. Among these, solely one species or a combination of two or more species can be used. In particular, biomass PET, biomass PTT, biomass HDPE, biomass LDPE, biomass LLDPE and biomass PP are preferable. Biomass PET is especially preferable. These biomass materials are resin materials and thus can be preferably used in an embodiment where the substrate is a resin film. With the use of the biomass material, the usage of fossil-resource-based materials can be reduced in the PSA sheet using the resin film (preferably a polyolefin film) as the substrate.

In the PSA sheet in an embodiment having a substrate, the biomass carbon ratio of the substrate is preferably 20% or higher, or more preferably 35% or higher. When the reduction of usage of fossil-resource-based materials is of greater importance, the biomass carbon ratio of the substrate can be, for instance, 50% or higher, 70% or higher, 85% or higher, or even 90% or higher. While the maximum biomass carbon ratio is 100% or lower, in some embodiments, in view of the ease of processing, strength, etc., the biomass carbon ratio of the substrate can be, for instance, 80% or lower, 60% or lower, 40% or lower, or even below 20%.

The face of the substrate (e.g. resin film, a rubber sheet, a foam sheet, etc.) on which the PSA layer is placed (i.e. the PSA layer side surface) may be subjected to a known or common surface treatment such as corona discharge treatment, plasma treatment, UV irradiation, acid treatment, base treatment and formation of a primer layer. Such surface treatment may be carried out to increase the tightness of adhesion between the substrate and the PSA layer, that is, the anchoring of the PSA layer to the substrate. Alternatively, the substrate may be free of any surface treatment to enhance the anchoring of the PSA layer side surface. When forming a primer layer, the primer used for the formation is not particularly limited and a suitable species can be selected among known primers. The thickness of the primer layer is not particularly limited. For instance, it can be above 0.01 μm; and it is suitably 0.1 μm or greater. From the standpoint of obtaining greater effects, it can also be 0.2 μm or greater. The thickness of the primer layer is preferably less than 1.0 μm, or possibly 0.7 μm or less, or even 0.5 μm or less. In general, primers are heavily dependent on fossil-resource-based materials; and therefore, from the standpoint of increasing the biomass carbon ratio of the PSA sheet described later, it may be advantageous that the primer layer does not have an excessively large thickness.

In a single-faced PSA sheet having a PSA layer on one face of the substrate, the PSA layer-free face (backside) of the substrate may be subjected to release treatment with a release agent (backside treatment agent). The backside treatment agent possibly used for formation of the backside treatment layer is not particularly limited. It is possible to use silicone-based backside treatment agents, fluorine-based backside treatment agents, long-chain alkyl-based backside treatment agents and other known or common agents in accordance with the purpose and application. For the backside treatment agent, solely one species or a combination of two or more species can be used.

To the substrate (e.g. a resin film substrate), various additives can be added as necessary, such as a filler (inorganic filler, organic filler, etc.), anti-aging agent, antioxidant, UV absorber, antistatic agent, slip agent, plasticizer and colorant (pigment, dye, etc.). The amount of the various additives is usually about 30% by weight or less (e.g. 20% by weight or less, typically 10% by weight or less) in the substrate. For instance, when a pigment (e.g. white pigment) is included in the substrate, the pigment content is suitably about 0.1% to 10% by weight (e.g. 1% to 8% by weight, typically 1% to 5% by weight).

The thickness of the substrate is not particularly limited and can be suitably selected in accordance with the purpose. In general, it is about 1 μm to 500 μm. From the standpoint of the handling properties of the substrate, the thickness of the substrate can be, for instance, 1.5 μm or greater, 2 μm or greater, 3 μm or greater, 4 μm or greater, or even 4.5 μm or greater. From the standpoint of making the PSA sheet thinner, in some embodiment, the thickness of the substrate can be, for instance, 150 μm or less, 100 μm or less, 50 μm or less, 25 μm or less, 20 μm or less, 10 μm or less, 7 μm or less, less than 5 μm, or even less than 4 μm.

### PSA sheet

The thickness (total thickness) of the PSA sheet disclosed herein (which includes the PSA layer and further includes the substrate in a substrate-supported PSA sheet, but excludes any release liner) is not particularly limited. It can be in a range of, for instance, about 2 μm to 1000 μm. In some embodiments, in view of the adhesive properties, etc., the thickness of the PSA sheet is preferably about 5 μm to 500 μm (e.g. 10 μm to 300 μm, typically 15 μm to 200 μm). Alternatively, in some embodiments where thinning is considered important, the PSA sheet may have a thickness of 100 μm or less (e.g. 5 μm to 100 μm), 70 μm or less (e.g. 5 μm to 70 μm), or even 45 μm or less (e.g. 5 μm to 45 μm).

In the PSA sheet disclosed herein, biomass-derived carbons preferably account for more than 40% of the total carbon content therein. In other words, the PSA sheet preferably has a biomass carbon ratio above 40%. With the use of a PSA sheet with such a high biomass carbon ratio, the usage of fossil-resource-based materials can be reduced. From such a standpoint, it can be said that the higher the biomass carbon ratio of the PSA sheet is, the more preferable it is. The biomass carbon ratio of the PSA sheet is preferably 50% or higher, possibly 60% or higher, 70% or higher, 75% or higher, or even 80% or higher. The maximum biomass carbon ratio is 100% by definition. In some embodiments, the biomass carbon ratio of the PSA sheet is below 100%. From the standpoint of obtaining high adhesive strength, in some embodiments, the biomass carbon ratio of the PSA sheet can be, for instance, 95% or lower. When adhesive properties are of greater importance, it can be 90% or lower, or even 85% or lower.

It is noted that in a PSA sheet without substrate, the biomass carbon ratio of the PSA layer equals that of the entire PSA sheet. Thus, when the PSA sheet disclosed herein is a PSA sheet without substrate, the biomass carbon ratio of the PSA sheet without substrate is 50% or higher, typically 50% or higher and lower than 100%.

The PSA sheet disclosed herein is preferably halogen-free (chlorine-free, in particular). A halogen-free PSA sheet can be made by avoiding the use of a halogen-containing material. For instance, with respect to the PSA layer, it is desirable to avoid using an additive that contains a halogenated polymer (e.g. a chlorinated rubber such as polychloroprene rubber). In a substrate-supported PSA sheet, it is desirable to avoid using, as a component of the substrate, a halogenated resin (e.g. vinyl chloride resin) or an additive that contains chlorine.

The PSA sheet disclosed herein is preferably constituted so that it satisfies at least one of the following: (A) the chlorine content is 0.09% (900 ppm) by weight or less, (B) the bromine content is 0.09% (900 ppm) by weight or less, and (C) their combined content (chlorine and bromine combined content) is 0.15% (1500 ppm) by weight or less. More preferably, at least (A) is satisfied. Yet more preferably, (A) and (C) are satisfied. Especially preferably, all (A), (B) and (C) are satisfied. The chlorine content and the bromine content can be determined by known methods such as fluorescent X-ray analysis and ion chromatography.

### Applications

The PSA sheet disclosed herein is not particularly limited in application and it can be applied to PSA sheets used in various applications. The PSA sheet disclosed herein can be preferably used, typically as a double-faced PSA sheet, to fix or attach parts. In an application using an adherend that includes both high-polar and low-polar materials, it is particularly significant to apply the PSA sheet disclosed herein. In favorable applications, it is applied to components of electronic devices to fix, attach or reinforce these components, etc. The double-faced sheet may be free of a substrate or may include a substrate. From the standpoint of making it thinner, in some embodiments, it may be preferable to select a form of a PSA sheet without substrate or a substrate-supported PSA sheet form that uses a thin substrate. As the thin substrate, a substrate having a thickness of 10 μm or less (e.g. less than 5 μm) can be preferably used.

The PSA sheet disclosed herein is suitable, for example, for fixing members in mobile electronic devices. Non-limiting examples of the mobile electronic devices include a cellular phone, a smartphone, a tablet type personal computer, a notebook type personal computer, various wearable devices (for example, wrist wearable devices such as a wrist watch, modular devices worn on part of a body with a clip, a strap, or the like, eyewear type devices inclusive of eyeglasses type devices (monocular and binocular type; including head-mounted device), devices attached to clothing, for example, in the form of an accessory on a shirt, a sock, a hat, or the like, earwear type devices which are attached to the ear, such as an earphone), a digital camera, a digital video camera, an acoustic device (a mobile music player, an IC recorder, and the like), a calculator (electronic calculator and the like), a mobile game machine, an electronic dictionary, an electronic notebook, an e-book reader, an information device for an automobile, a mobile radio, a mobile television, a mobile printer, a mobile scanner, and a mobile modem. The PSA sheet disclosed herein can be preferably used, for example, for the purpose of fixing a pressure-sensitive sensor and other members in those mobile electronic devices, among the abovementioned mobile electronic devices, that include a pressure-sensitive sensor. In some preferable embodiments, the PSA sheet can be used for fixing a pressure-sensitive sensor and other members in an electronic device (typically, a mobile electronic device) having a function of enabling the designation of an absolute position on a plate corresponding to the screen (typically, a touch panel) in an apparatus for indicating the position on a screen (typically, a pen type or a mouse type apparatus) and an apparatus for detecting the position. The term “mobile” in this description means not just providing simple mobility, but further providing a level of portability that allows an individual (average adult) to carry it relatively easily.

The matters disclosed herein include the following:
(1) A PSA having a PSA layer formed from a natural rubber-based PSA, wherein

the PSA comprises a base polymer formed with repeat units of which at least 20% by weight are derived from an acrylic monomer, and

the PSA layer includes biomass-derived carbons accounting for at least 50% of its total carbon content.
(2) The PSA sheet according to (1) above, the PSA sheet having an adhesive strength to a stainless steel plate of 18 N/20 mm or greater when determined at a peel angle of 180° at a tensile speed of 300 mm/min in an environment at 23° C. and 50% RH after the PSA sheet is press-bonded to the stainless steel plate as an adherend and the resultant is left at 50° C. for two hours.
(3) The PSA sheet according to (1) or (2) above, the PSA sheet having an adhesive strength to a polypropylene plate of 15 N/20 mm or greater when determined at a peel angle of 180° at a tensile speed of 300 mm/min in an environment at 23° C. and 50% RH after the PSA sheet is press-bonded to a polypropylene plate as an adherend and the resultant is left at 50° C. for two hours.
(4) The PSA sheet according to any of (1) to (3) above, the PSA sheet having an adhesive strength to a stainless steel plate of greater than 18.0 N/20 mm when determined at a peel angle of 180° at a tensile speed of 300 mm/min in an environment at 23° C. and 50% RH after the PSA sheet is press-bonded to the stainless steel plate as an adherend and the resultant is left at 50° C. for two hours.
(5) The PSA sheet according to any of (1) to (4) above, wherein the PSA layer comprises a plant-derived tackifier.
(6) The PSA sheet according to any of (1) to (5) above, wherein the PSA layer comprises, as a tackifier T1, at least one species selected among rosin-based tackifier resins and terpene-based tackifier resins.
(7) The PSA sheet according to any of (1) to (6) above, wherein the PSA layer comprises a phenolic tackifier resin as a tackifier T2.
(8) The PSA sheet according to (7) above, wherein the tackifiers T1 and T2 have weight fractions A1 and A2, respectively, at an A2 to A1 ratio (A2/A1) of 0.05 or higher and below 0.40.
(9) The PSA sheet according to any of (6) to (8) above, wherein the weight fraction A1 of the tackifier T1 is greater than 50 parts by weight and less than 100 parts by weight to 100 parts by weight of the base polymer.
(10) The PSA sheet according to any of (7) to (9), wherein the weight fraction A2 of the tackifier T2 is 5 parts by weight or greater and less than 30 parts by weight to 100 parts by weight of the base polymer.
(11) The PSA sheet according to any of (1) to (10), wherein the total tackifier content of the PSA layer is less than 100 parts by weight to 100 parts by weight of the base polymer.
(12) The PSA sheet according to any of (1) to (11), that is adhesively double-faced.
(13) The PSA sheet according to any of (1) to (12), used in an electronic device.
(14) The PSA sheet according to any of (1) to (13) above, wherein the plant-derived tackifier is included in an amount of 30 parts by weight or greater (typically 30 parts by weight or greater and 100 parts by weight or less) to 100 parts by weight of the base polymer.
(15) The PSA sheet according to any of (1) to (14) above, wherein the plant-derived tackifier comprises at least one species selected from the group consisting of terpene-based resins and modified terpene-based resins.
(16) The PSA sheet according to any of (1) to (15) above, wherein the PSA layer comprises a crosslinking agent and the crosslinking agent is selected among sulfur-free crosslinking agents.
(17) The PSA sheet according to (16) above, wherein the crosslinking agent comprises an isocyanate-based crosslinking agent.
(18) The PSA sheet according to any of (1) to (17) above, wherein the PSA layer includes a filler in an amount of less than 10 parts by weight (typically, 0 part by weight or greater and less than 10 parts by weight) to 100 parts by weight of the base polymer.
(19) The PSA sheet according to any of (1) to (18) above, wherein the PSA layer has a thickness of 15 μm or greater (typically 15 μm or greater and 500 μm or less).
(20) The PSA sheet according to any of (1) to (19) above, wherein the base polymer comprises an acrylate-modified natural rubber.
(21) The PSA sheet according to (20) above, wherein the acrylate-modified natural rubber is a natural rubber grafted with methyl methacrylate.
(22) The PSA sheet according to (20) or (21) above, wherein the acrylic monomer-derived repeat unit accounts for 1% or more and less than 80% of the entire acrylate-modified natural rubber by weight.
(23) The PSA sheet according to any of (1) to (22) above, formed as a substrate-free adhesively double-faced pressure-sensitive adhesive sheet formed of the pressure-sensitive adhesive layer.
(24) The PSA sheet according to any of (1) to (22) above, formed as a substrate-supported double-faced PSA sheet having a substrate supporting the PSA layer.
(25) The PSA sheet according to (24) above, wherein the substrate is a resin film.
(26) The PSA sheet according to (24) or (25), wherein the substrate comprises biomass-derived carbons accounting for 20% or more (typically 20% or more and 100% or less) of its total carbon content.
(27) The PSA sheet according to any of (1) to (26) above, comprising biomass-derived carbons accounting for at least 50% of its total carbon content.
(28) The PSA sheet according to any of (1) to (27) above that is free of halogens.
(29) The PSA sheet according to any of (1) to (28) above, used for fixing a part of an electronic device.

### EXAMPLES

Several working examples related to the present invention are described below, but these working examples are not to limit the present invention. In the description below, “parts” and “%” are by weight unless otherwise specified.

### Test Methods

### [To-SUS Adhesive Strength]

A PSA sheet is cut to a 20 mm wide, 150 mm long size to prepare a measurement sample. In an environment at 23° C. and 50% RH, the adhesive face of the measurement sample is exposed and press-bonded to a stainless steel plate (SUS304BA plate) as the adherend with a 2 kg rubber roller moved back and forth once. The resultant is left standing in an environment at 50° C. for two hours. Subsequently, in an environment at 23° C. and 50% RH, using a tensile tester, the peel strength (to-SUS adhesive strength) (N/20 mm) is determined at a peel angle of 180°, at a tensile speed of 300 mm/min, based on JIS Z0237:2000. As the tensile tester, a universal tensile/compression testing machine (machine name “tensile and compression testing machine, TCM-1kNB” available from Minebea Co., Ltd.) can be used.

It is noted that, for the measurement, a suitable backing material can be applied to the PSA sheet subject to measurement to reinforce it as necessary (e.g. in case of a PSA sheet without substrate, in case of a substrate-supported PSA sheet whose substrate is susceptible to deformation, etc.). As the backing material, for instance, PET film of about 25 μm in thickness can be used. This backing material was used in the working examples.

### [To-PP Adhesive Strength]

The to-PP adhesive strength (N/20 mm) is determined in the same manner as for the to-SUS adhesive strength except that a PP resin plate is used as the adherend.

### Example 1

### (Preparation of PSA Composition)

To a toluene solution containing 49 parts of natural rubber (RSS1 grade, after mastication), were added 36 parts of methyl methacrylate (MMA) and 0.4 part of a peroxide-based initiator and solution polymerization was carried out to obtain a toluene solution of acrylate-modified natural rubber A in which the natural rubber was grafted with MMA. As the peroxide-based initiator, were used BPO (product name NYPER BW available from NOF Corporation) and dilauroyl peroxide (product name PEROYL L available from NOF Corporation) at a weight ratio of about 1:1.7.

To the toluene solution of acrylate-modified natural rubber A, with respect to 100 parts of acrylate-modified natural rubber A in the solution, were added 70 parts of a terpene-based tackifier resin (product name YS RESIN PX1150N available from Yasuhara Chemical Co., Ltd.; softening point: 115° C.), 3 parts of an anti-aging agent (phenolic anti-aging agent, product name IRGANOX 1010 available from BASF Corporation) and 4 parts of an isocyanate-based crosslinking agent (product name CORONATE L available from Tosoh Corporation). The resulting mixture was allowed to stir evenly to prepare a PSA composition according to this Example.

### (Preparation of PSA Sheet)

To the release face of a 38 μm thick release liner (DIAFOIL MRF38 available from Mitsubishi Polyester Film, Inc.; or release liner R1, hereinafter) with the release face formed with a silicone-based release agent on one face of polyester film, was applied the PSA composition and allowed to dry at 100° C. for 2 minutes to form a 50 μm thick PSA layer. To the PSA layer, was adhered the release face of a 25 μm thick release liner (DIAFOIL MRF25 available from Mitsubishi Polyester Film, Inc.; or release liner R2, hereinafter) with the release face formed with a silicone-based release agent on one face of polyester film. By this, was obtained a substrate-free double-faced PSA sheet with the two faces protected with the two polyester release liners R1 and R2.

### Example 2

Using 90 parts of the terpene-based tackifier resin per 100 parts of the acrylate-modified natural rubber A, but otherwise in the same manner as Example 1, was obtained a double-faced PSA sheet according to this Example.

### Example 3

As the tackifier resin, were used 50 parts of the terpene-based tackifier resin (product name YS RESIN PX1150N available from Yasuhara Chemical Co., Ltd.; softening point 115° C.) and 20 parts of terpene-phenol resin A (product name SUMILITE RESIN PR-12603N available from Sumitomo Bakelite Co., Ltd.; softening point 133° C.) per 100 parts of acrylate-modified natural rubber A. Otherwise in the same manner as Example 1, was obtained a double-faced PSA sheet according to this Example.

### Example 4

Using 40 parts of the terpene-based tackifier resin and 30 parts of terpene-phenol resin A to 100 parts of acrylate-modified natural rubber A, but otherwise in the same manner as Example 3, was obtained a PSA sheet according to this Example.

### Example 5

In place of the terpene-phenol resin A, were used 30 parts in total of two different resins at 1:1 weight ratio per 100 parts of acrylate-modified natural rubber A, the two resins being terpene-phenol resin B (product name YS POLYSTER S145 available from Yasuhara Chemical Co., Ltd.; softening point 145° C., hydroxyl value 100 mgKOH/g) and terpene-phenol resin C (product name YS POLYSTER T145 available from Yasuhara Chemical Co., Ltd.; softening point 145° C., hydroxyl value 60 mgKOH/g). Otherwise in the same manner as Example 4, was obtained a PSA sheet according to this Example.

### Example 6

As the tackifier resin, were used 70 parts of the terpene-based tackifier resin (product name YS RESIN PX1150N available from Yasuhara Chemical Co., Ltd.; softening point 115° C.) and 20 parts of terpene-phenol resin A (product name SUMILITE RESIN PR-12603N available from Sumitomo Bakelite Co., Ltd.; softening point 133° C.) per 100 parts of acrylate-modified natural rubber A. Otherwise in the same manner as Example 1, was obtained a PSA sheet according to this Example.

### Example 7

In place of terpene-phenol resin A, was used terpene-phenol resin D (product name TAMANOL 803L available from Arakawa Chemical Industries, Ltd.; softening point: about 145-160° C., hydroxyl value 1-20 mgKOH/g). Otherwise in the same manner as Example 6, was obtained a PSA sheet according to this Example.

### Example 8

In place of the terpene-phenol resin A, were used 20 parts in total of two different resins at 1:1 weight ratio per 100 parts of acrylate-modified natural rubber A, the two resins being terpene-phenol resin B (product name YS POLYSTER S145 available from Yasuhara Chemical Co., Ltd.; softening point 145° C., hydroxyl value 100 mgKOH/g) and terpene-phenol resin C (product name YS POLYSTER T145 available from Yasuhara Chemical Co., Ltd.; softening point 145° C., hydroxyl value 60 mgKOH/g). Otherwise in the same manner as Example 6, was obtained a PSA sheet according to this Example.

### Example 9

As the tackifier resin, were used 70 parts of the terpene-based tackifier resin (product name YS RESIN PX1150N available from Yasuhara Chemical Co., Ltd.; softening point 115° C.) and 30 parts of terpene-phenol resin A (product name SUMILITE RESIN PR-12603N available from Sumitomo Bakelite Co., Ltd.; softening point 133° C.) per 100 parts of acrylate-modified natural rubber A. Otherwise in the same manner as Example 1, was obtained a PSA sheet according to this Example.

### Example 10

As the tackifier resin, were used 80 parts of the terpene-based tackifier resin (product name YS RESIN PX1150N available from Yasuhara Chemical Co., Ltd.; softening point 115° C.) and 20 parts of terpene-phenol resin A (product name SUMILITE RESIN PR-12603N available from Sumitomo Bakelite Co., Ltd.; softening point 133° C.) per 100 parts of acrylate-modified natural rubber A. Otherwise in the same manner as Example 1, was obtained a PSA sheet according to this Example.

### Measurements and Evaluations

With respect to the PSA sheet according to each Example, the to-SUS adhesive strength (N/20 mm) and the to-PP adhesive strength (N/20 mm) were determined. In addition, with respect to the PSA according to each Example, the biobased content of the PSA forming the PSA layer was determined based on ASTM D6866. The results are shown in Table 1. The symbol “-” in the adhesive strength column indicates that it was not determined.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Composition (parts) | | | | | | | | | | |
| Acrylate-modified rubber | 100 | 100 | 100 | 100 | 100 | 100 | 100 | 100 | 100 | 100 |
| Terpene resin | 70 | 90 | 50 | 40 | 40 | 70 | 70 | 70 | 70 | 80 |
| Terpene-phenol resin A | 0 | 0 | 20 | 30 | 0 | 20 | 0 | 0 | 30 | 20 |
| Terpene-phenol resin B | 0 | 0 | 0 | 0 | 15 | 0 | 0 | 10 | 0 | 0 |
| Terpene-phenol resin C | 0 | 0 | 0 | 0 | 15 | 0 | 0 | 10 | 0 | 0 |
| Terpene-phenol resin D | 0 | 0 | 0 | 0 | 0 | 0 | 20 | 0 | 0 | 0 |
| Anti-aging agent | 3 | 3 | 3 | 3 | 3 | 3 | 3 | 3 | 3 | 3 |
| Crosslinking agent | 4 | 4 | 4 | 4 | 4 | 4 | 4 | 4 | 4 | 4 |
| Biobase degree of PSA (%) | 85 | 86 | 73 | 75 | 75 | 80 | 80 | 80 | 79 | 82 |
| Evaluations | | | | | | | | | | |
| To-SUS adhesive strength (N/20 mm) | 16.8 | 17.5 | 16.7 | 15.6 | 16.6 | 20.8 | 21.2 | 22.5 | — | — |
| To-PP adhesive strength (N/20 mm) | 16.3 | 16.5 | 15.4 | 13.8 | 15.5 | 19.3 | 19.3 | 19.0 | — | — |

As shown in Table 1, in Examples 6 to 8, to-SUS adhesive strength values of 18 N/20 mm or greater and to-PP adhesive strength values of 15 N/20 mm or greater were obtained. On the other hand, Examples 1 to 5 showed significantly lower values than Examples 6 to 8 in both to-SUS adhesive strength and to-PP adhesive strength. With respect to Examples 9 and 10, the surfaces of the PSA layers were not uniform in quality; and therefore, their adhesive strength were not evaluated. As shown by these results, when a natural rubber based PSA comprising at least a certain percentage of acrylic monomer-derived repeat units was used, the resulting PSA sheet showed excellent adhesive strength to high-polar and low-polar adherends while the dependence on fossil-resource-based materials was reduced.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 2, 3 PSA sheets
10 support substrate
10A first face
10B second face (backside)
21 PSA layer (first PSA layer)
21A adhesive face (first adhesive face)
21B second adhesive face
22 PSA layer (second PSA layer)
22A adhesive face (second adhesive face)
31, 32 release liners
100, 200, 300 release-linered PSA sheets

What is claimed is:

1. A pressure-sensitive adhesive sheet having a pressure-sensitive adhesive layer formed from a natural rubber-based pressure-sensitive adhesive, wherein
the pressure-sensitive adhesive comprises a base polymer formed with repeat units of which at least 20% by weight are derived from an acrylic monomer,
the pressure-sensitive adhesive layer includes biomass-derived carbons accounting for at least 50% of its total carbon content,
the pressure-sensitive adhesive sheet has an adhesive strength to a stainless steel plate of 18 N/20 mm or greater, determined at a peel angle of 180° at a tensile speed of 300 mm/min in an environment at 23° C. and 50% RH after the pressure-sensitive adhesive sheet is press-bonded to the stainless steel plate as an adherend and the resultant is left at 50° C. for two hours, and
the pressure-sensitive adhesive sheet has an adhesive strength to a polypropylene plate of 15 N/20 mm or greater, determined at a peel angle of 180° at a tensile speed of 300 mm/min in an environment at 23° C. and 50% RH after the pressure-sensitive adhesive sheet is press-bonded to a polypropylene plate as an adherend and the resultant is left at 50° C. for two hours.

2. The pressure-sensitive adhesive sheet according to claim 1, having an adhesive strength to a stainless steel plate of greater than 18.0 N/20 mm, determined at a peel angle of 180° at a tensile speed of 300 mm/min in an environment at 23° C. and 50% RH after the pressure-sensitive adhesive sheet is press-bonded to the stainless steel plate as an adherend and the resultant is left at 50° C. for two hours.

3. The pressure-sensitive adhesive sheet according to claim 1, wherein the pressure-sensitive adhesive layer includes a plant-derived tackifier.

4. The pressure-sensitive adhesive sheet according to claim 1, wherein the pressure-sensitive adhesive layer comprises, as a tackifier T1, at least one species selected among rosin-based tackifier resins and terpene-based tackifier resins; and further comprises, as a tackifier T2, a phenolic tackifier resin.

5. The pressure-sensitive adhesive sheet according to claim 4, wherein the tackifiers T1 and T2 have weight fractions A1 and A2, respectively, at an A2 to A1 ratio (A2/A1) of 0.05 or higher and lower than 0.40.

6. The pressure-sensitive adhesive sheet according to claim 4, wherein the weight fraction A1 of the tackifier T1 is greater than 50 parts by weight and less than 100 parts by weight to 100 parts by weight of the base polymer.

7. The pressure-sensitive adhesive sheet according to claim 4, wherein the weight fraction A2 of the tackifier T2 is 5 parts by weight or greater and less than 30 parts by weight to 100 parts by weight of the base polymer.

8. The pressure-sensitive adhesive sheet according to claim 1, wherein the total tackifier content of the pressure-sensitive adhesive layer is less than 100 parts by weight to 100 parts by weight of the base polymer.

9. The pressure-sensitive adhesive sheet according to claim 1, that is adhesively double-faced.

10. The pressure-sensitive adhesive sheet according to claim 1, used in an electronic device.

11. The pressure-sensitive adhesive sheet according to claim 3, the plant-derived tackifier is included in an amount of 30 parts by weight or more to 100 parts by weight of the base polymer.

12. The pressure-sensitive adhesive sheet according to claim 1, wherein the pressure-sensitive adhesive layer includes a crosslinking agent and the crosslinking agent is selected among sulfur-free crosslinking agents.

13. The pressure-sensitive adhesive sheet according to claim 1, wherein the pressure-sensitive adhesive layer includes a filler in an amount of less than 10 parts by weight to 100 parts by weight of the base polymer.

14. The pressure-sensitive adhesive sheet according to claim 1, wherein the pressure-sensitive adhesive layer has a thickness of 15 μm or greater.

15. The pressure-sensitive adhesive sheet according to claim 1, wherein the base polymer comprises an acrylate-modified natural rubber.

16. The pressure-sensitive adhesive sheet according to claim 1, consisting of the pressure-sensitive adhesive layer.

17. The pressure-sensitive adhesive sheet according to claim 1, formed as a substrate-supported adhesively double-faced pressure-sensitive adhesive sheet having a substrate supporting the pressure-sensitive adhesive layer.

18. The pressure-sensitive adhesive sheet according to claim 17, wherein the substrate is a resin film.

19. The pressure-sensitive adhesive sheet according to claim 17, wherein at least 20% of all carbons in the substrate are biomass-derived carbons.

20. The pressure-sensitive adhesive sheet according to claim 1, wherein at least 50% of all carbons in the pressure-sensitive adhesive sheet are biomass-derived carbons.
